(19) United States
(12) Patent Application Publication
(10) Pub. No.: US 2007/0150595 A1
(43) Pub. Date: Jun. 28, 2007

(54) Identifying information services and schedule times to implement load management

(75) Inventors: Aayaz Bhorania, Bellevue, WA (US); Wei Wei Ada Cho, Issaquah, WA (US); Liang Ge, Duvall, WA (US); Stephen R. Husak, Snoqualmie, WA (US); Frederic Azera, Kirkland, WA (US); Colin L. Acton, Kirkland, WA (US)

Correspondence Address: SENNIGER POWERS (MSFT), ONE METROPOLITAN SQUARE, 16TH FLOOR, ST. LOUIS, MO, 63102, US

(73) Assignee: Microsoft Corporation, Redmond, WA (US)

(21) Appl. No.: 11/318,050

(22) Filed: Dec. 23, 2005

(51) Int. Cl. G06F 15/173

(52) U.S. Cl. 709/226

(57) ABSTRACT

Identifying a location and download schedule of web services. Responsive to a request from the application program, the system generates a list of the web services available to an application program along with locations and schedule times associated with the web services. The schedule times implement load management of the web services. The application program accesses the web services at the identified locations at the determined schedule times.

### BACKGROUND

Today, many applications are web accessible and web enabled. These types of applications are commonly referred to as web services. Web services reside on networks such as the Internet and allow client applications to access them and obtain information. Web services utilize several standards, such as Simple Object Access Protocol (SOAP), eXtensible Mark-up Language (XML), Web Services Description Language (WSDL), Universal Description Discovery and Integration (UDDI), and the like. These standards provide the mechanisms for tagging data, transferring the data, and identifying the web services. They also allow web services to operate independent of any specific operating system or protocol.

Media application programs executing on computing devices often request different types of metadata (e.g., television program listings, movie posters, album information, digital versatile disc chapters) from metadata web services to provide a compelling user experience. In typical systems, each of the application programs communicates with the metadata web services via a protocol specific to that application program. The metadata web services, however, are required to support each specific protocol resulting in additional complexity and logic for the metadata web services. Further, typical metadata web services lack a central, generic system for formulating and delivering metadata packages to any of the media application programs.

Typical media applications are able to locate and interact with the metadata web services. There is no mechanism in typical systems, however, for managing the workload of requests from the media applications programs among multiple metadata web services.

### SUMMARY

Embodiments of the invention include a directory service for providing an application program, computing device, client, or the like with a list of web services available to the application program. In addition, the directory service provides a download schedule associated with each of the web services to implement load management of the web services. The application program accesses one or more of the available web services according to the download schedule.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is an exemplary block diagram illustrating the interaction between a client and the directory service and the package delivery service.

FIG. 2 is an illustrative network illustrating a client application accessing web services.

FIG. 3 is an exemplary block diagram illustrating clients accessing the directory service and subsequently accessing other web services.

FIG. 4 is an exemplary block diagram illustrating an MDP request and MDP response.

FIG. 5 is an exemplary block diagram illustrating the structure of the metadata download protocol architecture.

FIG. 6 is an exemplary block diagram illustrating the sequence of operations performed according to the metadata download protocol.

FIG. 7 is an exemplary block diagram illustrating operation of the directory service.

FIG. 8A and FIG. 8B illustrate an exemplary schema for input XML to the directory service.

FIG. 9 is an exemplary block diagram illustrating the interaction between a client and an information service hosting the directory service and the package delivery service.

FIG. 10 is an exemplary block diagram illustrating packages being provided to the package delivery service by data providers.

FIG. 11 is an exemplary flow chart illustrating operation of the PDS backend.

FIG. 12 is another exemplary flow chart illustrating operation of the PDS backend.

Corresponding reference characters indicate corresponding parts throughout the drawings.

### DETAILED DESCRIPTION

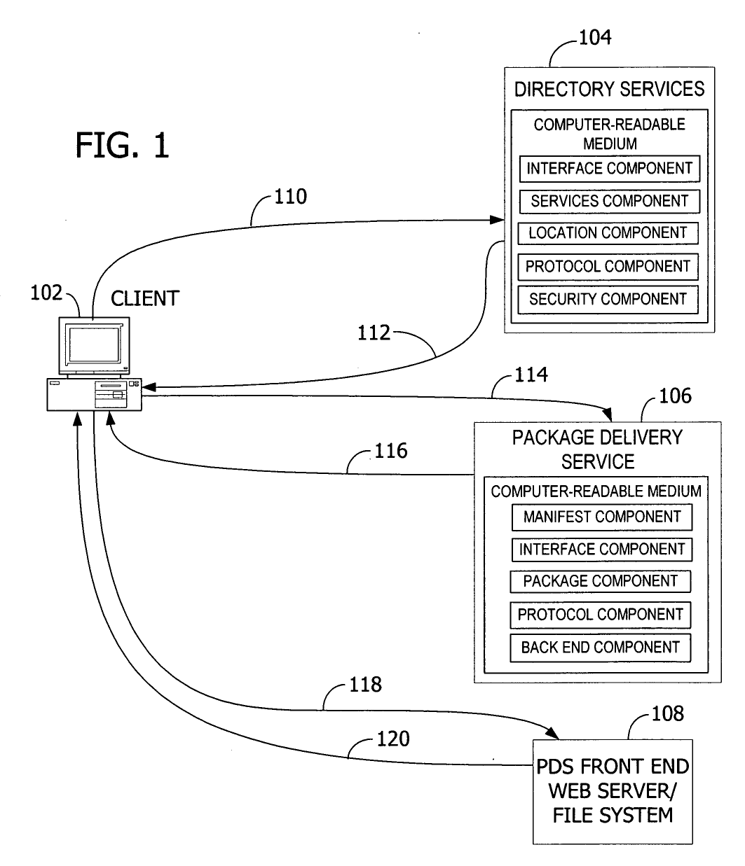

Referring first to FIG. 1, an exemplary block diagram illustrates the interaction between a client 102 (e.g., an application program) and a directory service 104 and a package delivery service (PDS) 106. At 110, the client 102 makes periodic calls to the directory service 104. The directory service 104 returns a list of web services and schedules that are available to the client 102 at 112. The package delivery service 106 is one of the web services. The client 102 calls the package delivery service 106 and passes country, package name, and package version information at 114. The package delivery service 106 identifies a location of a metadata package requested by the client 102. The location of the package file is returned to the client 102 along with an encryption key at 116. The client 102 makes a request to download the package file at 118. The application program downloads the desired metadata package from the identified location at 120 (e.g., the PDS front end web server/file system 108). The application program communicates with the directory service 104 and the package delivery service 106 via a metadata download protocol. Exemplary metadata packages include sports schedules, sports templates, and client updates. In another embodiment, the metadata package includes television program guide listings.

In one embodiment, one or more computer-readable media have computer-executable components for implementing the directory service 104. Exemplary components include an interface component, a services component, a location component, a protocol component, and a security component. The interface component receives a request from an application program (e.g., client 102) for one or more locations providing web services. The services component generates a list of the web services corresponding to the received request. The location component identifies the requested locations as a function of the generated list of the web services and determines a schedule time associated with each of the identified locations to effectuate load management at the identified locations. The protocol component formats the identified locations, the generated list of the web services, and the determined schedule times according to a metadata download protocol to create formatted objects. The interface component sends the formatted objects along with a common header to the application program. The application program accesses the web services at the identified locations at the determined schedule times. The security component generates a security token based on the received request prior to sending the identified locations, the generated list of the web services, and the determined schedule times to the application program.

In one embodiment, one or more computer-readable media have computer-executable components for implementing the package delivery service 106. Exemplary components include a manifest component, an interface component, a package component, a protocol component, and a back end component. The manifest component maintains a plurality of metadata packages and manifests associated therewith. Each of the plurality of metadata packages has a location corresponding thereto. The interface component receives a request for a metadata package from an application program (e.g., client 102). The request comprises attributes including at least one of a package type, a client version, an identifier of an original equipment manufacturer of a computing device executing the application program, and a country code. The package component filters the maintained plurality of metadata packages based on one or more of the attributes to identify at least one metadata package. The protocol component formats the metadata package according to a metadata exchange format. The protocol component further generates a security token based on the received request. The interface component sends the formatted metadata package to the application program along with the generated security token. In one embodiment, the metadata package is encrypted and the protocol component further sends an encryption key to the application program.

The back end component receives a particular metadata package and a corresponding manifest from a metadata provider. The back end component further conforms the received manifest to a particular manifest schema and stores the received metadata package and the conformed manifest in a data store.

In one embodiment, the package delivery service 106 also provides a decryption key to the application program for decrypting the metadata package after downloading. The package delivery service 106 provides data integrity by ensuring that the metadata packages come from a trusted source and have not been tampered with.

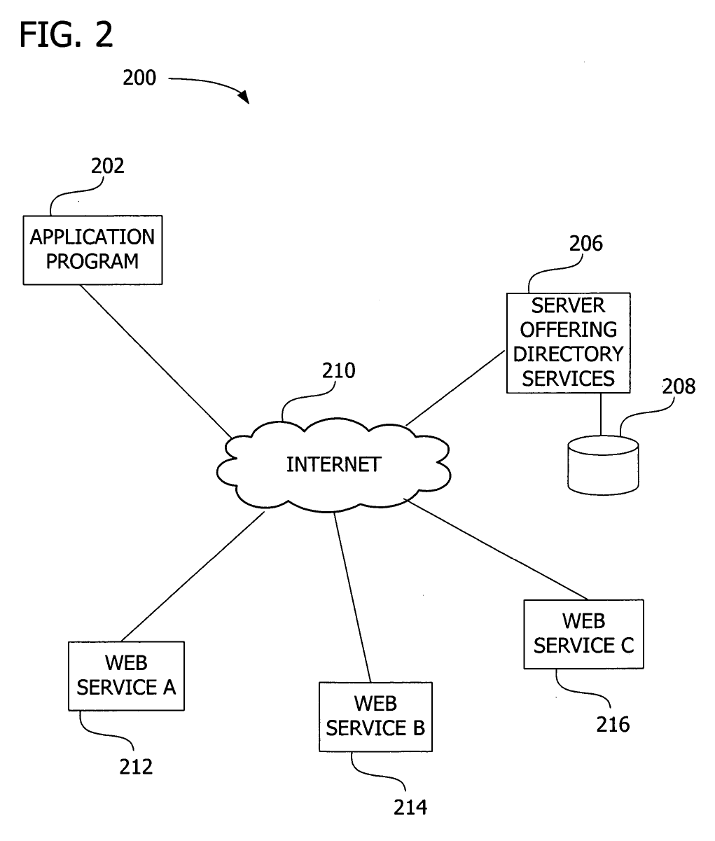

A general example of web services is next described in FIG. 2. A description of a metadata exchange format and an implementation of the metadata download protocol follow. Exemplary implementations of the directory service 104 and the package delivery service 106 are then described.

Web Services

FIG. 2 is a system 200 in which two or more computing devices are arranged to implement the directory services aspect of the invention. Each computing device may host an entire software component or host a partial component for the directory services. The components of the present method may each reside on one or more computing devices.

An exemplary directory services system includes, but is not limited to, an application program 202, a server 206 offering directory services, and web services A (212), B (214), and C (216). These components communicate over a network 210, such as the Internet. The directory services aspect of the invention identifies one or more of the web services (e.g., web services 212-216) that the application program 202 may access for information. However, the location of these web services 212-216 may change over time. Therefore, the present web service locater method provides techniques and mechanisms for making these location changes transparent to the application program 202.

The system of FIG. 2 may also include storage 208 that is accessible by the server 206. The storage 208 maintains a current location for each web service 212-216. Using storage 208, the server 206 identifies the location of one or more requested web services to the application program 202. The application program 202 then invokes the requested web services at the identified location. The web services 212-216 deliver metadata to the application program 202 in a format such as the metadata exchange format next described.

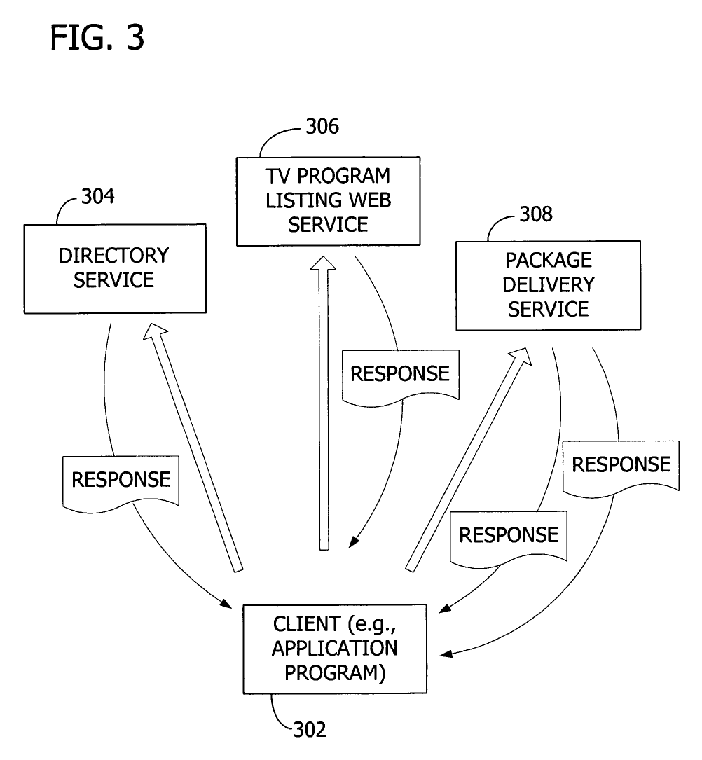

FIG. 3 is a block diagram illustrating the interaction of a client 302 (e.g., an application program) with the directory service 304, a television program listing web service 306, and a package delivery service 308.

The exemplary operating environment illustrated in FIG. 2 and FIG. 3 includes a general purpose computing device (e.g., computing device 604) such as a computer executing computer-executable instructions. The computing device 604 typically has at least some form of computer readable media (e.g., computer-readable medium 606 or computer-readable medium 622). Computer readable media, which include both volatile and nonvolatile media, removable and non-removable media, may be any available medium that may be accessed by the general purpose computing device. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media. The computing device includes or has access to computer storage media in the form of removable and/or non-removable, volatile and/or nonvolatile memory. The computing device may operate in a networked environment using logical connections to one or more remote computers.

Although described in connection with an exemplary computing system environment, aspects of the invention are operational with numerous other general purpose or special purpose computing system environments or configurations. The computing system environment is not intended to suggest any limitation as to the scope of use or functionality of aspects of the invention. Moreover, the computing system environment should not be interpreted as having any dependency or requirement relating to any one or combination of components illustrated in the exemplary operating environment. Examples of well known computing systems, environments, and/or configurations that may be suitable for use in embodiments of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other computing devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

Metadata eXchange Format (MXF)

The MXF is a generic and extensible XML schema that allows any metadata to be exchanged with an application program to be defined as objects in the XML that map one to one into a store on the client. MXF is applicable to the delivery of any data including electronic programming guide line-up and listings (e.g., ATSC).

An exemplary MXF schema includes a root element that wraps the other elements in the XML document. Exemplary child elements and an attribute are shown below.

TABLE 1
Exemplary Data Elements and Attribute for MXF.

| | Data Type | Description |
|---|---|---|
| Data Element | | |
| suppliers | String | Represents the supplier and source |
| | | information about the data in the file |
| Types | String | Represent the types of objects defined in |
| | | the file and the assemblies which contain |
| | | their implementation |
| Objects | Stored | Application specific first class objects |
| | Objects | |
| Attribute | | |
| Version | String | Schema version of the mxf |

One example is shown below.

```
<mxf version=“1.0”>
    <suppliers>
        <supplier/>
        <supplier/>
    </suppliers>
    <types>
        <type/>
    </types>
    <objects>
    </objects>
</mxf>
```

Another example is shown below.

<MXF version=“1.0” xmlns=“”>
<Assembly name=“mcstore”>
<NameSpace name=“Media.Store”>
<Type name=“Attachment” parentFieldName=“Package” />
<Type name=“Package” />
<Type name=“UId” parentFieldName=“target” />
<Type name=“Provider” />
</NameSpace>
</Assembly>
<Provider id=“WMIS”>
<UId>!Media.ProviderNames!IS</UId>
</Provider>
<StoredObjects provider=“IS”>
<Package id=“SportsSchedule” version=“20050916.0737”>
<UId>!Services.Platform.Apps.Mdp.Packages!SportsSchedule</UId>
</Package>
<Attachment package=“SportsSchedule” name=“SportsSchedule”
fileVersion=“495595035668”
url=“http://YINGLITESERVER:1700/packagedeliverydata/SportsSchedule
/SportsSchedule-495595035668.0-4.00-All-20050914.enc”
IV=“guI3Zx/wbDOWXO8wvDlehQ==”
key=“Wx/Jz0mTEGKuTjq9VVBy8yB/wgvifi3/dIoOmOipNpk=”
signature=“IPk27MYrcrfrXyvSIEpyzN3EKptLm0xemBgbGTQpKbc=”
encryptionMethod=“AES128” signingMethod=“SHA256”
microsoftCodeSigned=“False” />
</StoredObjects>
</MXF>

Yet another example is shown below.

```
class Person : StoredObject
    {
    [Stored] String firstName;
    [Stored] String lastName;
    [Stored] Person mother;
    [Stored] Person father;
    }
<Person id=“John Doe Jr” firstName=“John” lastName=“Doe”>
    <father firstName=“John” lastName=“Doe”/>
</Person>
<Person id=“Jane Doe” firstName=“Jane” lastName=“Doe”>
</Person>
<Person id=“Billy Doe” firstName=“Billy” lastName=“Doe”
mother=“Jane Doe”>
    <father idref=“John Doe Jr”/>
</Person>
```

Metadata Download Protocol (MDP)

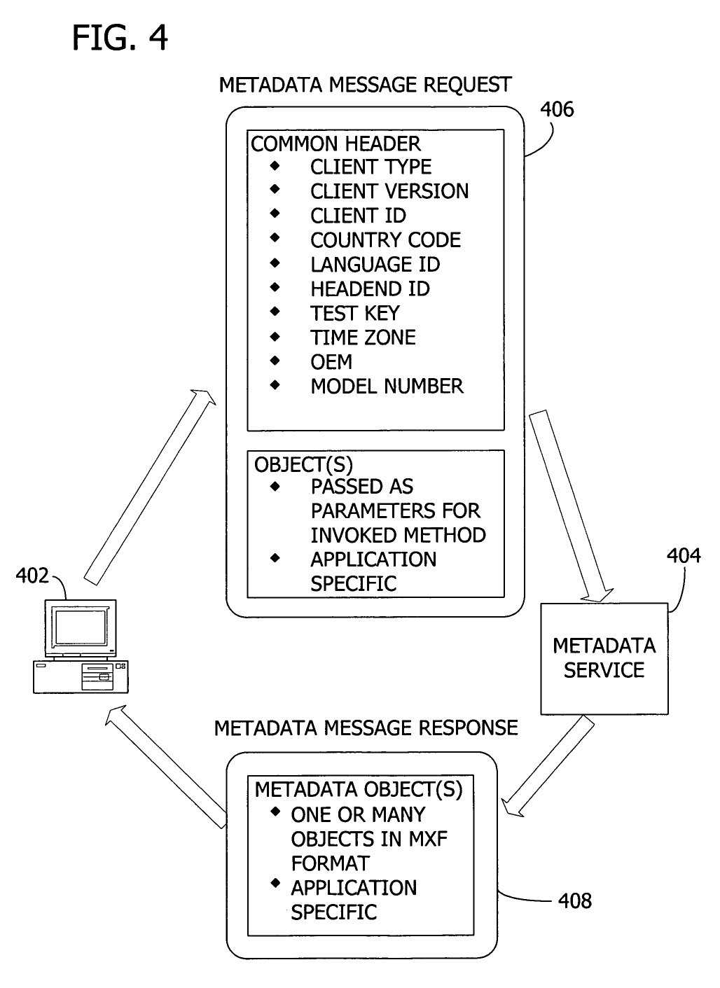

Referring next to FIG. 4, an exemplary block diagram illustrates a generic invoke method for a computing device 402 to download data from another computing device (e.g., a computing device executing the metadata service 404) via the MDP. MDP provides cost effectiveness and consistency across web services. In one embodiment, the MDP is based on the simple object access protocol (SOAP) and a client such as computing device 402 downloads data from a web information services server. The MDP provides a set of common entry points into each web service to enable the client to (e.g., a download manager executing on the client) to use each service without the need for multiple proxies for determining versioning and package availability. Further, MDP provides a virtually transparent mechanism for the logging of the common header information as well as arbitrary parameters. MDP also provides security via security token validation in addition to normal data handling practices such as authentication, extensible markup language (XML) validation, parameters checking, and the like. MDP ensures metadata confidentiality and integrity when requesting and downloading any type of metadata.

An application program executing on the computing device 402 calls a common interface implemented by each web service (e.g., metadata service 404) that uses MDP. An example of such a common interface is shown below.
XmlNode GetPackage(string packageName, string version, MdpParameterCollection parameters)

The packageName parameter is optional but allows the web service to switch on the name if necessary. The version parameter allows the computing device 402 to specify the current version of the data package it already has. Some services may ignore the version information and return data each time regardless of what is requested.

Calling the common interface results in a metadata message request 406 being sent from the computing device 402 to the web service (e.g., metadata service 404). The metadata service 404 executing on a server delivers the requested data to the computing device 402 as a metadata message response 408 (e.g., as an XML document).

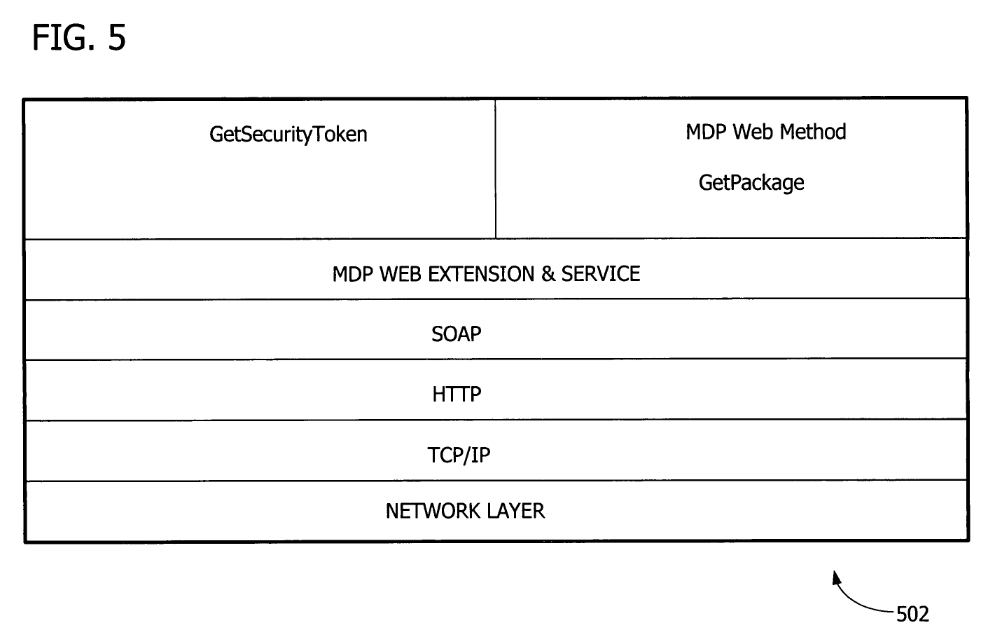

Referring next to FIG. 5, a block diagram illustrates the exemplary layers 502 of an implementation of the MDP. Above the basic network and protocol layers (e.g., TCP/IP HTTP, and SOAP), an MDP Web Extension and Service layer is installed to handle SOAP requests and responses before and after the MDP Web Method GetPackage( ) is called. It is within this layer, in one embodiment, that MDP exists as a service providing methods for parameter validation, logging, and the security implementation through a GetSecurityToken( ) web method.

MDP also exists as an interface layer (e.g., abstract class called MdpWebService) that each web service inherits from clients to enable the delivery of data directly into the client store. MDP also provides a SOAP Extension class used for the common header information passing, logging of parameters and parameter validation. An MDP request message from an application program includes a common header and one or more objects. Object(s) are passed as parameters, are application-specific, and can be in any format. The structure of an exemplary client request is shown below. In the request, the header defines a set of standard and common data elements that should be included in metadata objects.

TABLE 1
Exemplary Data Elements in an MDP Request.

| Data | | |
|---|---|---|
| Element | Data Type | Description |
| Client | String | Client type |
| Type | Min char length: 1 | Sample value: “Home” |
| | Max char length: 10 | |
| Client | String | Version of the client. |
| Version | Min char length: 3 | Sample value: 4.00 |
| | Max char length: 3 | |
| | Format: x.xx, x is a | |
| | number | |
| Client ID | GUID | Unique ID of the client, which is also |
| | | known as the device ID |
| Country | String | 2-characters country code of the client |
| Code | Min char length: 2 | Sample value: us |
| | Max char length: 2 | |
| Language | String | 2-letter or 3-letter language code from |
| ID | Min char length: 2 | CultureInfo class |
| | Max char length: 3 | Sample value: en |
| Test Key | String | Key that is used for testing a beta |
| | Min char length: 5 | service before it goes live. It enables |
| | Max char length: 25 | a different set of service entries to be |
| | | returned. |
| | | Sample value: Test123 |
| Time | String | Time Zone that the client is in |
| Zone | Min char length: 1 | Sample value: PST |
| | Max char length: 10 | |
| OEM | String | OEM name of the client. This is used |
| | Min char length: 1 | for reporting only |
| | Max char length: 50 | Sample value: HP |
| Model | String | Model number of the client computing |
| | Min char length: 1 | device. This is used for reporting only |
| | Max char length: 25 | Sample value: m7100y |

The web service responds to the request from the application program by sending the requested data as data objects. In an embodiment including the directory service and the package delivery service, the objects are defined in MXF as described above.

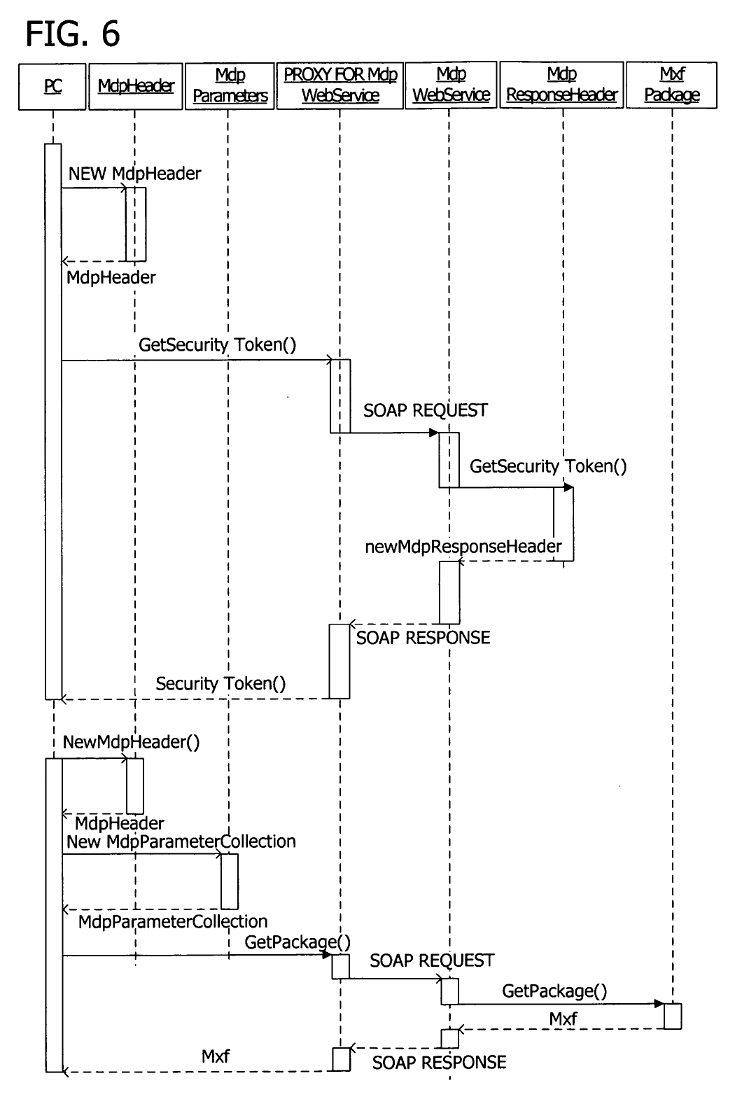

In one embodiment, MDP provides security in the form of client authentication via security tokens generated by the web service, data integrity via file checksums, content protection via secure communications, and encryption and signature of metadata packages. Some of these security mechanisms are shown in FIG. 6.

Referring next to FIG. 6, a block diagram illustrates an exemplary sequence of operations involved in MDP. In FIG. 6, the new MdpHeader operation and the new MdpParameterCollection operation instantiate the MdpHeader and MdpParameterCollection data structures, respectively.

Exemplary methods for implementing MDP are described in Appendix A. Appendix B describes the available attributes and fields in an exemplary MDP packet. Appendix C describes exemplary elements of an MDP implementation. Appendix D includes an exemplary web service implementation using MDP.

Directory Service

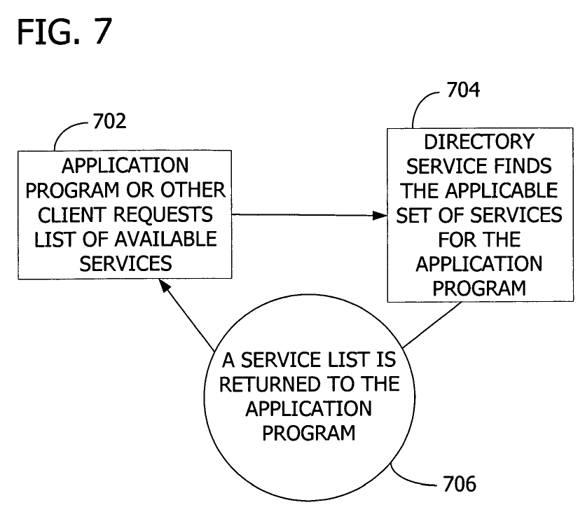

Referring next to FIG. 7, a block diagram illustrates the directory service cycle. An application program or other client requests a list of available services at 702 from the directory service. The directory service finds a list of the web services and package delivery services that are available to the application program at 704. The directory service returns the list of web services at 706 and their related access schedule (e.g., a service list) that an application program wants to know about, based on attributes such as a client identifier. The directory service may key off any attributes including those defined in the MDP header. Application programs on the computing devices use the information from the directory service to locate and subscribe to package delivery services. The directory service in one embodiment of the invention provides information about where and when particular web services should be accessed by the application programs. The directory service includes load management to distribute requests from application programs over time and location to manage the load on the servers providing web services. In one embodiment, the application program executing on the computing device includes an update manager which requests and receives a set of objects defining a service list from the directory service on a regular basis (e.g., daily).

A schema for the service list defines the countries supported, the languages supported, the client version supported, and the latest package version available on the server. Appendix E describes an exemplary database schema for the directory service.

Appendix F includes a sample file that defines available services and schedule information. Appendix G lists an exemplary schema definition for a directory service implementation. Appendix H includes exemplary input and output for the directory service.

Exemplary interaction between an application program and the directory service is next described. The connection with the directory service is initiated by the application program over HTTPS using MDP and includes the creation of a security token. This token is unique and created via the metadata download protocol from a unique client pair: client identifier and client token. Once this security token is created, it is used by the directory service to authenticate the application program to return the directory service list (e.g., the list of services and references or pointers to metadata packages). The token is also used by each web service to send a decryption key or other sensitive data to the application program.

After authentication of the application program, the directory service returns a list of available services and access information (e.g., in MXF). The application program uses this information to make additional requests for services of interest. Similar information is also returned by the directory service to the application program to tell it when, where and how to make the next connection to the directory service itself. The Directory Service takes into account factors such as the client type, client version, country code, and language identifier when determining what services are available to a specific application program.

The list of available services (e.g., the service list) includes a list of service entries. There is at least one service entry per web service and one service entry for the directory service itself. Each service entry includes a service key, a test key, a service uniform resource identifier (URL), and a download schedule. The service key is a unique service type string (e.g., “Sports-Real-Time”). The test key is a unique service type string (e.g., “Sports-Real-Time-TEST”) that is used when the service is not to be seen by production users. Only those that have the corresponding Test Key in the client registry will be able to see this service. The service URL indicates whether a secure sockets layer is in use. The download schedule is indicated by the tuple of {download window start, download window duration, download delta days, refresh hours, retry count, backoff min, backoff max}.

For example, a tuple of (2 am, 60 minutes, 0 days, 12 hours, 3, 10 minutes, 1 hour) yields the following semantics: “the application program should schedule downloads at a random point chosen in the window 2 am to 3 am, utc time, and every 12 hours thereafter. If there is a connectivity or server error, the application program should retry until successful, up to a maximum of 3 retries. For each retry the application program should back off an amount of time that is randomly chosen between 10 minutes and 1 hour.” In another example, a tuple of (2 am, 60 minutes, 2 days, 0 hours, 3, 10 minutes, 1 hour) yields the following semantics: “the application program should schedule downloads at a random point chosen in the window 2 am to 3 am, utc time, and every 2 days thereafter. If there is a connectivity or server error, the application program should retry until successful, up to a maximum of 3 retries. For each retry the application program should back off an amount of time that is randomly chosen between 10 minutes and 1 hour.” The web service may specify the precise time (e.g., to the minute) that the application program should attempt to download.

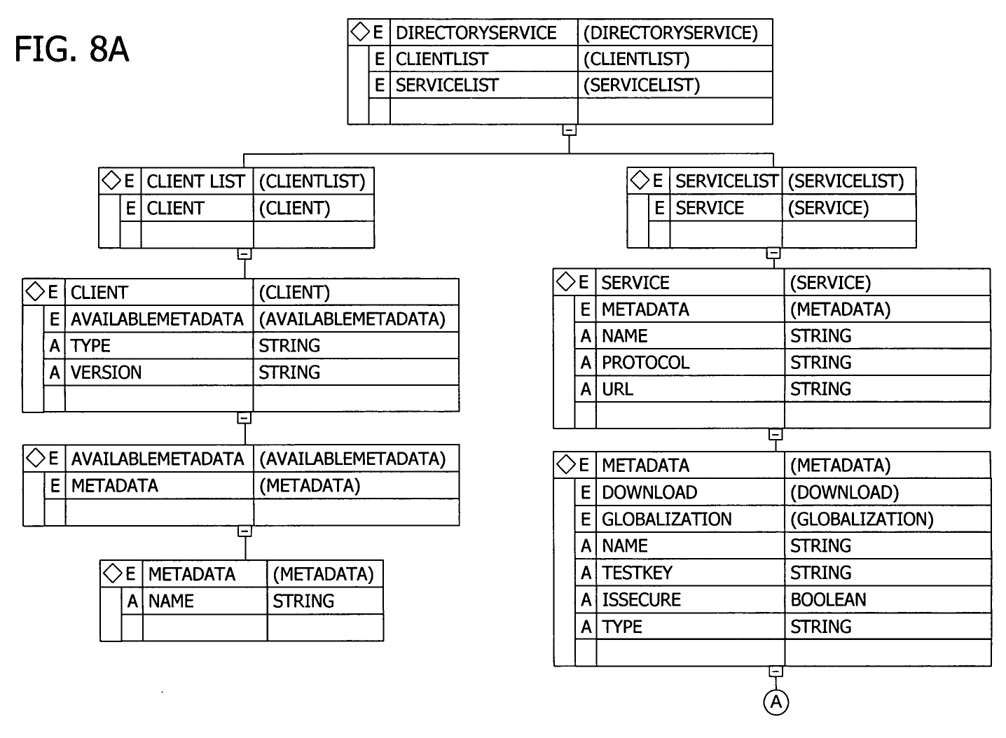

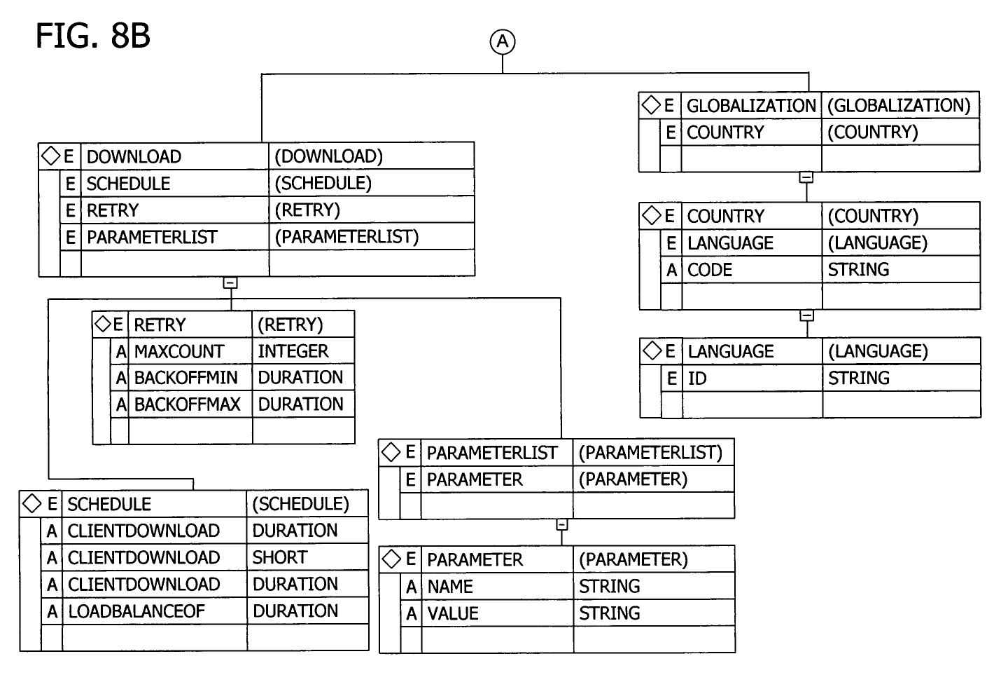

FIG. 8A and FIG. 8B illustrates an exemplary schema for the service list loaded into the directory service by metadata providers. Appendix I describes the contents of this imported service list.

An exemplary directory service has several pipe line stages including back-end stages such as a data collector service, a data loading service, a publication stage service, and a publication activation service for polling for updates to the service list, loading the service list into a database, preparing the service list for publication, and making the service list available to the front-end web service, respectively. These pipeline stages are described in greater detail in Appendix J.

After an application program obtains a list of available services and corresponding download schedules, the application program accesses any of the services according to the download schedule corresponding thereto. One such service is the package delivery service, which is next described.

Package Delivery Service (PDS)

The package delivery service (PDS) is a web service that maintains a plurality of metadata packages (or information thereof) available for downloading by a computing device, application program, or the like. For example, the PDS stores the locations and encryption keys associated with each of the metadata packages. Responsive to a request from a computing device, the PDS filters the plurality of metadata packages (or information thereof) to identify a metadata package requested by the computing device. The PDS provides a location of the identified metadata package to the computing device. In one embodiment, the PDS filters the information based on a client version, original equipment manufacturer associated with the computing device, and country code. In another embodiment, the PDS filters the information based on a package type.

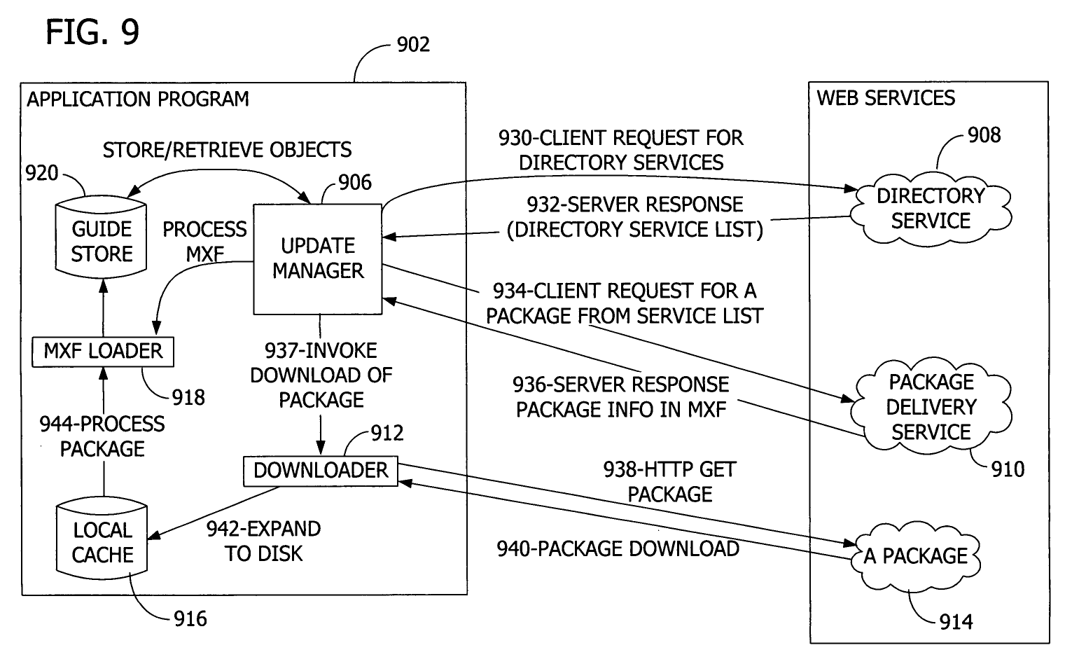

Referring next to FIG. 9, an exemplary block diagram illustrates the interaction between an application program 902 (or other client) and a particular implementation of the directory service 908 and the package delivery service 910. In operation, an application program 902 subscribes to the PDS 910. An update manager 906 associated with the application program 902 retrieves the location and download schedule time for the package delivery service 910 from the directory service 908 by sending a client request for delivery services at 930 and receiving a server response at 932. For example, the application program 902 may receive a PackageDeliveryService object such as shown below that specifies the what, where, when, and how of package delivery. The “what” is identified by the package field. “Where” and “how” are specified by the webServiceLocator, and “when” is specified by the remaining fields.

class PackageDeliveryService : StoredObject
{
[Stored] Package package;
[Stored] WebServiceLocator webServiceLocator;
[Stored] KeyValues parameters;
[Stored] DateTime expires;
[Stored] DateTime nextTime;
[Stored] TimeSpan nextTimeLength;
[Stored] TimeSpan failureWait;
[Stored] Int32 retryCount;
[Stored] TimeSpan minRetryWait;
[Stored] TimeSpan maxRetryWait;
}

Based on this PackageDeliveryService object, the update manager 906 schedules a task to access the PDS 910. In one embodiment, a security token is created via an MDP connection between the application program 902 and PDS 910. The application program 902 queries the PDS 910 for the location of a particular metadata package 914 by sending a client request for a package at 934. The PDS 910 sends a server response with the package information to the update manager 906 at 936. The application program 902 invokes the download of the particular metadata package 914 at 937. A downloader 912 downloads the particular metadata package 914 by sending, for example, an HTTP GetPackage request at 938 and receiving the package 914 at 940. In one embodiment, the PDS 910 ensures data integrity by digitally signing and encrypting the metadata package 914.

After receiving the package 914, the downloader 912 expands the received package 914 to a disk or other computer-readable medium such as local cache 916 at 942. The received package 914 is processed at 944 by an MXF loader 918 and stored in a guide store 920. The update manager 906 also has access to the guide store 920 and the MXF loader 918.

In one embodiment, the PDS 910 supports the following package types, each of which have one XML manifest file: a client update, a sports schedule, and a sports template. The client update package includes miscellaneous client configuration settings such as channel frequencies and channel presets. In one example, application programs download this package once every six months. The sports schedule package contains sports schedule and channel tuning information that is downloaded to the client via PDS. In one example, this package is downloaded by application programs or other clients twice a day. The sports template package includes miscellaneous sports assets including, but not limited to, sports data provider with attribution, URLs to real-time data, design assets, templates, tuning heuristics, and league priority. In one example, application programs download the sports template package once every season.

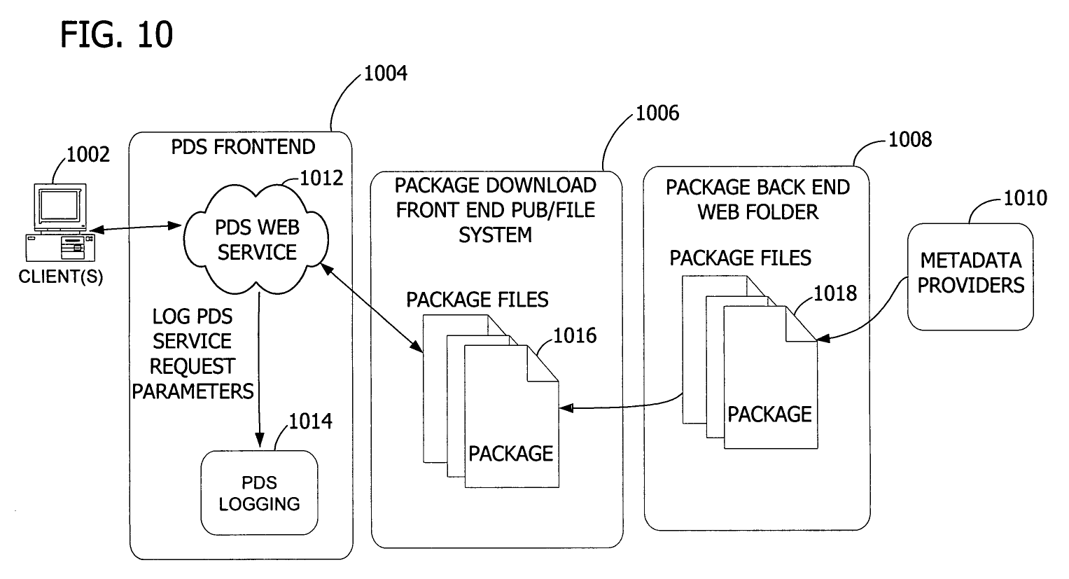

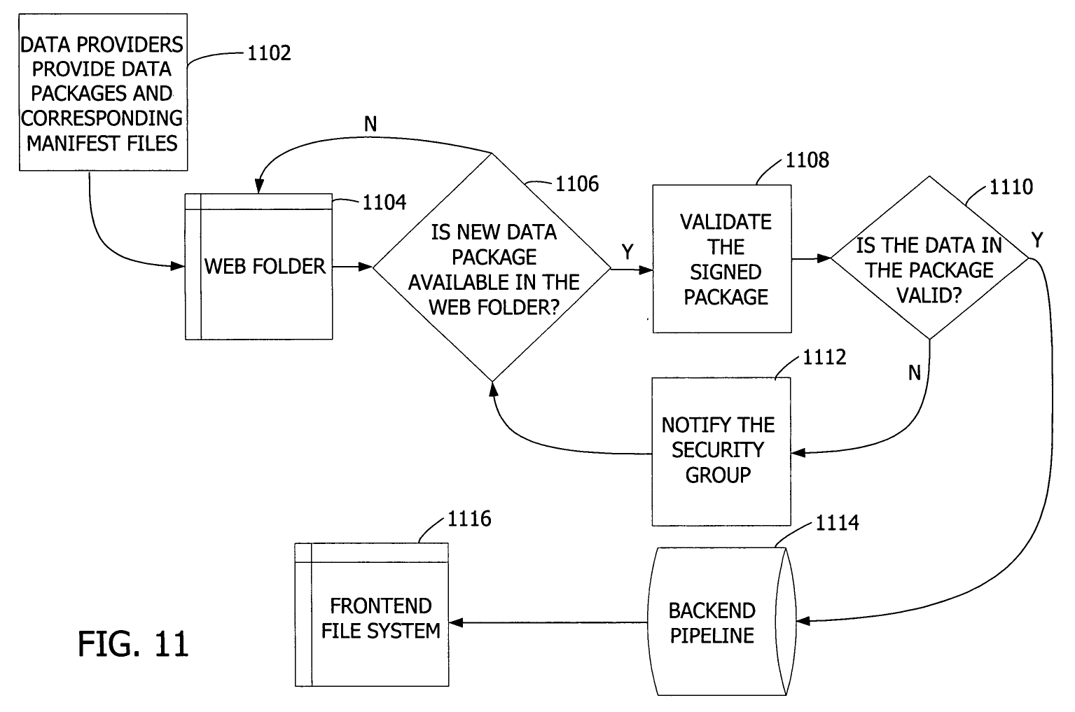

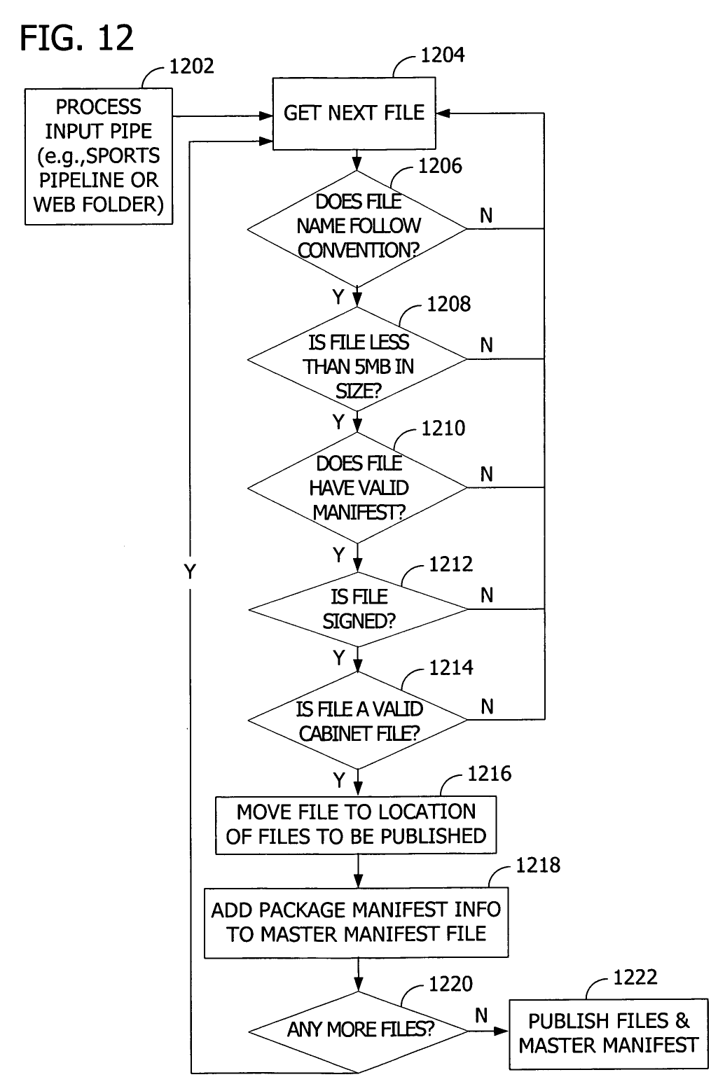

Referring next to FIG. 10, the PDS such as PDS 910 in FIG. 9 receives metadata packages such as package 914 in FIG. 9 and those described above from metadata providers 1010. An exemplary backend architecture for receiving these packages is illustrated in FIG. 10, FIG. 11, and FIG. 12 and described in Appendix K. In particular, the metadata providers 1010 store package files 1018 in a package back end web folder 1008. A package download front end publication/file system 1006 processes the package files 1018 into package files 1016. A PDS web service 1012 in the PDS front end 1004 accesses the package files 1016 to deliver the package files 1016 to one or more clients 1002. PDS service request parameters are logged to a PDS logging component 1014.

Referring next to FIG. 11 and FIG. 12, flow charts illustrate operation of the block diagram in FIG. 10. Each package type has a manifest file describing the package contents. The manifest is an .xml file in one embodiment. Received manifests are validated against an XSD. Each package within a manifest is capable of being filtered based on one or more of the following filters: country, OEM, client version, file name, file version, attachment name, and encryption key. These filters are seen in the example XML below as <Filter> elements.

Filters will be applied in the order they are encountered in the manifest. If the filter element does not match the client parameters, that entire element is skipped. In the following example any client that is not US or CA will not match. Clients with a “4.0” version from US or CA will match “ClientUpdate-2.0-4.0-all-05052005.cab”. US or CA clients that are any version besides “4.0” will match “ClientUpdate-2.0-all-all-05052005.cab”.

```
<Filter name=“CountryCode” value=“US,CA”>
  <Filter name=“ClientVersion” value=“4.0”>
    <PackageFile fileName=“ClientUpdate-2.0-4.0-all-05052005.cab”
availableVersion=“2.0”/>
  </Filter>
  <PackageFile fileName=“ClientUpdate-2.0-all-all-05052005.cab”
availableVersion=“2.0”/>
</Filter>
```

The front-end web service implementation of PDS uses MDP. The PDS service implements the GetPackage method such as shown below.

XmlNode GetPackage(string packageName, string version,
MdpParameterCollection params)

The internal code of GetPackage determines if the client needs a new package by comparing the packageName and version parameters with the list of packages and version(s) in the master file manifest, created as a part of the file propagation service (FPS).

The XmlNode returned to the client has an empty MXF node if the client has the latest version of the given package. The XmlNode returned contains a link to the latest package if the client does not have the latest version of the given package. The returned XmlNode is in MXF format. An example indicating that a new download is needed is shown below.

```
<MXF version=“1.0” xmlns=“”>
  <Assembly name=“mcstore”>
    <NameSpace name=“Microsoft.MediaCenter.Store”>
      <Type name=“Attachment” parentFieldName=“Package”
/>
      <Type name=“Package” />
      <Type name=“UId” parentFieldName=“target” />
      <Type name=“Provider” />
    </NameSpace>
  </Assembly>
  <Provider id=“WMIS”>
    <UId>!Microsoft.MediaCenter.ProviderNames!WMIS</UId>
  </Provider>
  <StoredObjects provider=“WMIS”>
    <Package id=“ClientUpdate” version=“20050915.1604”>
<UId>!Microsoft.WindowsMedia.Services.Platform.Apps.Mdp.Packages
!ClientUpdate</UId>
    </Package>
    <Attachment package=“ClientUpdate” name=“ClientUpdate1”
fileVersion=“2.0”
url=“http://KTDESK:1700/packagedeliverydata/ClientUpdate/Client
Update-2.0-6.0-ALL-20050505.enc”
IV=“jkNEJS1t+wITN7NNsAbOBw==”
key=“6CgVXDoM9xyhzI9sBLopoR5StqP3cMrCdmMu3U7UHdY=”
signature=“Oe0TXqGu7MH4HOdbFrrGa5t5s3C2n06oOZr8ZDg5jRo=”
encryptionMethod=“AES128” signingMethod=“SHA256”
microsoftCodeSigned=“True” />
    <Attachment package=“ClientUpdate” name=“ClientUpdate2”
fileVersion=“2.0”
url=“http://KTDESK:1700/packagedeliverydata/ClientUpdate/Client
Update-2.0-6.0-ALL2-20050505.enc”
IV=“cKcdQSkQNmtJxJfjNsGvkw==”
key=“KdmvqLbbdOQYiWgFR6muMhbfbETnK3NkvdtifrEpK1s=”
signature=“cEdysmeuXHlfmyb4bbn9fukG8kPxowNTidZGBMQqB04=”
encryptionMethod=“AES128” signingMethod=“SHA256”
microsoftCodeSigned=“True” />
    <Attachment package=“ClientUpdate” name=“ClientUpdate4”
fileVersion=“2.0”
url=“http://KTDESK:1700/packagedeliverydata/ClientUpdate/Client
Update-2.0-6.2-DELLOTHER-20050505.enc”
IV=“NfhBAbdux9MxE1S2geZAtw==”
key=“62tcavYgHZqgqauOEnsT9vTUsAaJ5s8kmvUBm5xxu5A=”
signature=“Tlu0imgh5Is7CMbE8LxrmrfX5nmKwIiLWY8zygmr84w=”
encryptionMethod=37 AES128” signingMethod=“SHA256”
microsoftCodeSigned=“True” />
    <Attachment package=“ClientUpdate” name=“ClientUpdate6”
fileVersion=“2.0”
url=“http://KTDESK:1700/packagedeliverydata/ClientUpdate/Client
Update-2.0-6.0-ALLOEM-20050505.enc”
IV=“ueWd5Uvr8GzkC4dOceCSaw==”
key=“x8AuE2MppD/ML08zvrNl7C8oJB548pGJOv/O90ER+7o=”
signature=“36LRxhHQx2U8Aga8WRDOjMDViYhn/R90zLrCT6/o+pQ=”
encryptionMethod=“AES128” signingMethod=“SHA256”
microsoftCodeSigned=“True” />
  </StoredObjects>
</MXF>
```

When no filters are set for a given package, that package is returned to all clients. When filters are set to a specific value, a client with that exact configuration matches the packages corresponding to the filter. For example, if a package has the following CountryCode filter: <Filter name=“CountryCode” value=“US”>, then that package goes to US clients. It does not go to UK clients; only an exact match is valid. When a filter value is set to star (*) that filter matches any value for the given filter. For example, if the filter CountryCode is set to a star, that matches any country.

When finding matches, the manifest is searched from top to bottom in one embodiment. If an exact match is encountered for a given filter, from that point in the file down that filter is not used to find subsequent matches. For example, if a match is found with the filter: <Filter name=“CountryCode” value=“US”>, it is an exact match and no more CountryCode matches are reported. Specifically, if <Filter name=“CountryCode” value=“*”> is encountered later in the same manifest file, it is not a match. When a match is found with a star, it has no affect on finding further matches.

The follow are example update scenarios. Given that the following packages are available, the matches returned are shown in the table below.

```
<?xml version=“1.0” encoding=“utf-8”?>
<PackageName xmlns:xsd=“http://www.w3.org/2001/XMLSchema”
xmlns:xsi=“http://www.w3.org/2001/XMLSchema-instance”
name=“SportsSchedule”>
  <PackageFile name=“File1.cab” availableVersion=“1.0”
key=“abc” />
  <Filter name=“OEM” value=“Dell”>
    <PackageFile name=“File8.cab” availableVersion=“1.0”
key=“abc” />
    <Filter name=“ClientVersion” value=“1.0”>
      <Filter name=“CountryCode” value=“US”>
        <PackageFile fileName=“File2_Dell.cab”
availableVersion=“1.0” />
      </Filter>
      <Filter name=“CountryCode” value=“CA”>
        <PackageFile fileName =“File3_Dell.cab”
availableVersion=“1.0” />
      </Filter>
      <Filter name=“CountryCode” value=“JP”>
        <PackageFile fileName =“File4_Dell.cab”
availableVersion=“1.0” />
      </Filter>
      <Filter name=“CountryCode” value=“*”>
        <PackageFile fileName =“File7_Dell.cab”
availableVersion=“1.0” />
      </Filter>
    </Filter>
  </Filter>
  <Filter name=“OEM” value=“HP”>
    <Filter name=“ClientVersion” value=“1.0”>
      <Filter name=“CountryCode” value=“US”>
        <PackageFile fileName =“File9_HP.cab”
availableVersion=“1.0” />
      </Filter>
      <Filter name=“CountryCode” value=“CA”>
        <PackageFile fileName =“File10_HP.cab”
availableVersion=“1.0” />
      </Filter>
      <Filter name=“CountryCode” value=“JP”>
        <PackageFile fileName =“File11_HP.cab”
availableVersion=“1.0” />
      </Filter>
      <Filter name=“CountryCode” value=“*”>
        <PackageFile fileName =“File14_HP.cab”
availableVersion=“1.0” />
      </Filter>
    </Filter>
  </Filter>
</PackageName>
```

TABLE 2
Matches Returned.

| Client Details | |
|---|---|
| (Sent with GetPackage) | Matches Returned to the Client |
| ClientPackageVersion = “0.0” | File1.cab |
| CountryCode = “US” | File8.cab |
| OEM = “Dell” | File2_Dell.cab |
| Package = “SportsSchedule” | |
| . . . | |
| ClientPackageVersion = “0.0” | File1.cab |
| CountryCode = “US” | File9_HP.cab |
| OEM = “HP” | |
| Package = “SportsSchedule” | |
| . . . | |
| ClientPackageVersion = “0.0” | File1.cab |
| CountryCode = “CA” | File8.cab |
| OEM = “Dell” | File3_Dell.cab |
| Package = “SportsSchedule” | |
| . . . | |
| ClientPackageVersion = “4.0” | None |
| CountryCode = “CA” | (Also unexpected. Client package version |
| OEM = “Dell” | is greater than those available for |
| Package = “SportsSchedule” | download.) |
| . . . | |

Appendix L lists a sample manifest file for the package delivery service. Appendix M includes sample input and output for the package delivery service. Appendix N defines an exemplary schema definition for a manifest file in the package delivery service.

Hardware, software, firmware, computer-executable components, computer-executable instructions, and/or the elements of the figures constitute means for determining and providing a list of web services available to the application program, means for identifying the metadata package requested by the application program, and means for communicating with the application program according to a metadata download protocol.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above constructions, products, and methods without departing from the scope of aspects of the invention, it is intended that all matter contained in the above description and shown in the accompanying drawings shall be interpreted as illustrative and not in a limiting sense.

### Appendix A

Exemplary methods for implementing MDP are shown below.
void GetSecurityToken(string clientAuthToken)
Client calls GetSecurityToken to get a security token for the client that is used in subsequent calls. This is handled in the MDP code.
   XmlNode GetPackage(string packageName, string version, MdpParameterCollection parameters)
Client calls GetPackage to invoke the web service—the web service returns the MXF from here based on the input parameters. This is handled in the web service code that uses MDP.
   GetSecurityToken Implements Client Authentication.
   GetPackage
   MDP WILL validate all parameters that are passed into this web method—if this has failed, the method will not be called.
   MDP WILL insure it is called over a secure connection (if required) and/or a valid security token is passed (if required)—if this has failed, the method will not be called.
   MDP WILL log all parameters into this function automatically (but only if they are valid, and only if it is set to log)
   This method REQUIRES that the MdpHeader is passed in. MDP will copy the parameters in the header to the MdpParameterCollection for implementers ease-of-use, however, the header is also available directly
      MDP Attributes
   The MdpExtensionAttribute class is the object that holds the values for the attributes set.
   The implementer MUST set the following:
      ServiceName (e.g. “DirectoryService”)
      logMemberName
         This is a variable in the wrapping class that will get the value of the MDP Log object at runtime.
   The implementer MAY set the following:
      Logging
         Specifies the type of logging needed for the web method
      Secure
         Specifies that the web method is to be secured (i.e. don't allow it to be called via HTTP)
      SecurityToken
         Specifies that the web method expects the security token to be valid and correct
      MxfSchemaPath
         Specifies the file location to the schema for the MXF returned by the GetPackage( ) method
            MDP Attribute Example
[MdpExtension(“ParameterEcho”, “MdpLog”, Secure=true,
Logging=MDP_LOG_TYPES.MDP_LOG_TYPE_IIS |
MDP_LOG_TYPES.MDP_LOG_TYPE_UNIFIEDLOG |
MDP_LOG_TYPES.MDP_LOG_TYPE_COUNTER |
MDP_LOG_TYPES.MDP_LOG_TYPE_SOAP_MSG_OUT |
MDP_LOG_TYPES.MDP_LOG_TYPE_SOAP_MSG_IN)]
[SoapHeader(“RequestHeader”, Direction=SoapHeaderDirection.In)]
[WebMethod(Description=“GetPackage for PDS”)]
public override XmlNode GetPackage(string packageName, string version, MdpParameterCollection parameters)

This attribute specifies a service name of “ParameterEcho” using the “MdpLog” property (or field) for the log object and then specifies that log lines will go to the IIS Log, Unified Log, and a counter is used. Also SOAP messages (both incoming and outgoing) will be logged. This GetPackage method can only be called over a secure connection.

### Appendix B

An exemplary web services description language (WSDL) for MDP is shown below.

```
    <?xml version=“1.0” encoding=“utf-8”?>
    <wsdl:definitions xmlns:sl=“http://microsoft.com/wsdl/types/”
    xmlns:http=“http://schemas.xmlsoap.org/wsdl/http/”
    xmlns:soap=“http://schemas.xmlsoap.org/wsdl/soap/”
    xmlns:s=“http://www.w3.org/2001/XMLSchema”
    xmlns:soapenc=“http://schemas.xmlsoap.org/soap/encoding/”
    xmlns:tns=“http://www.microsoft.com/WindowsMedia/MDP/2005/10/10/Core”
    xmlns:tm=“http://microsoft.com/wsdl/mime/textMatching/”
    xmlns:mime=“http://schemas.xmlsoap.org/wsdl/mime/”
    targetNamespace=“http://www.microsoft.com/WindowsMedia/MDP/2005/10/10
    /Core” xmlns:wsdl=“http://schemas.xmlsoap.org/wsdl/”>
      <wsdl:types>
        <s:schema elementFormDefault=“qualified”
    targetNamespace=“http://www.microsoft.com/WindowsMedia/MDP/2005/10/10
    /Core”>
          <s:import namespace=“http://microsoft.com/wsdl/types/” />
          <s:element name=“GetPackage”>
            <s:complexType>
              <s:sequence>
                <s:element minOccurs=“0” maxOccurs=“1” name=“packageName”
    type=“s:string” />
                <s:element minOccurs=“0” maxOccurs=“1” name=“version”
    type=“s:string” />
                <s:element minOccurs=“0” maxOccurs=“1” name=“parameters”
    type=“tns:MdpParameterCollection” />
              </s:sequence>
            </s:complexType>
          </s:element>
          <s:complexType name=“MdpParameterCollection”>
            <s:sequence>
              <s:element minOccurs=“0” maxOccurs=“1” name=“MdpParameters”
    type=“tns:ArrayOfMdpParameter” />
            </s:sequence>
          </s:complexType>
          <s:complexType name=“ArrayOfMdpParameter”>
            <s:sequence>
              <s:element minOccurs=“0” maxOccurs=“unbounded”
    name=“MdpParameter” nillable=“true” type=“tns:MdpParameter” />
            </s:sequence>
          </s:complexType>
          <s:complexType name=“MdpParameter”>
            <s:sequence>
              <s:element minOccurs=“0” maxOccurs=“1” name=“Key”
    type=“s:string” />
              <s:element minOccurs=“0” maxOccurs=“1” name=“Value”
    type=“s:string” />
            </s:sequence>
          </s:complexType>
          <s:element name=“Get PackageResponse”>
            <s:complexType>
              <s:sequence>
                <s:element minOccurs=“0” maxOccurs=“1”
    name=“GetPackageResult”>
                  <s:complexType mixed=“true”>
                    <s:sequence>
                      <s:any />
                    </s:sequence>
                  </s:complexType>
                </s:element>
              </s:sequence>
            </s:complexType>
          </s:element>
          <s:element name=“MdpHeader” type=“tns:MdpHeader” />
          <s:complexType name=“MdpHeader”>
            <s:sequence>
              <s:element minOccurs=“0” maxOccurs=“1” name=“ClientType”
    type=“s:string” />
              <s:element minOccurs=“0” maxOccurs=“1” name=“ClientVersion”
    type=“s:string” />
              <s:element minOccurs=“1” maxOccurs=“1” name=“ClientId”
    type=“s1:guid” />
              <s:element minOccurs=“0” maxOccurs=“1” name=“CountryCode”
    type=“s:string” />
              <s:element minOccurs=“0” maxOccurs=“1” name=“LanguageId”
    type=“s:string” />
              <s:element minOccurs=“0” maxOccurs=“1” name=“TestKey”
    type=“s:string” />
              <s:element minOccurs=“0” maxOccurs=“1” name=“Timezone”
    type=“s:integer” />
              <s:element minOccurs=“0” maxOccurs=“1” name=“Oem”
    type=“s:string” />
              <s:element minOccurs=“0” maxOccurs=“1” name=“OemModel”
    type=“s:string” />
              <s:element minOccurs=“0” maxOccurs=“1” name=“SecurityToken”
    type=“s:string” />
            </s:sequence>
          </s:complexType>
          <s:element name=“GetSecurityToken”>
            <s:complexType>
              <s:sequence>
                <s:element minOccurs=“0” maxOccurs=“1”
    name=“clientAuthToken” type=“s:string” />
              </s:sequence>
            </s:complexType>
          </s:element>
          <s:element name=“GetSecurityTokenResponse”>
            <s:complexType />
          </s:element>
          <s:element name=“MdpReturnHeader” type=“tns:MdpReturnHeader” />
          <s:complexType name=“MdpReturnHeader”>
            <s:sequence>
              <s:element minOccurs=“0” maxOccurs=“1” name=“SecurityToken”
    type=“s:string” />
            </s:sequence>
          </s:complexType>
        </s:schema>
        <s:schema elementFormDefault=“qualified”
    targetNamespace=“http://microsoft.com/wsdl/types/”>
          <s:simpleType name=“guid”>
            <s:restriction base=“s:string”>
              <s:pattern value=“[0-9a-fA-F]{8}-[0-9a-fA-F]{4}-[0-9a-fA-
    F]{4}-[0-9a-fA-F]{4}-[0-9a-fA-F]{12}” />
            </s:restriction>
          </s:simpleType>
        </s:schema>
      </wsdl:types>
      <wsdl:message name=“GetPackageSoapIn”>
        <wsdl:part name=“parameters” element=“tns:GetPackage” />
      </wsdl:message>
      <wsdl:message name=“GetPackageSoapOut”>
        <wsdl:part name=“parameters” element=“tns:GetPackageResponse” />
      </wsdl:message>
      <wsdl:message name=“GetPackageMdpHeader”>
        <wsdl:part name=“MdpHeader” element=“tns:MdpHeader” />
      </wsdl:message>
      <wsdl:message name=“GetSecurityTokenSoapIn”>
        <wsdl:part name=“parameters” element=“tns:GetSecurityToken” />
      </wsdl:message>
      <wsdl:message name=“GetSecurityTokenSoapOut”>
        <wsdl:part name=“parameters”
    element=“tns:GetSecurityTokenResponse” />
      </wsdl:message>
      <wsdl:message name=“GetSecurityTokenMdpHeader”>
        <wsdl:part name=“MdpHeader” element=“tns:MdpHeader” />
      </wsdl:message>
      <wsdl:message name=“GetSecurityTokenMdpReturnHeader”>
        <wsdl:part name=“MdpReturnHeader” element=“tns:MdpReturnHeader”
    />
      </wsdl:message>
      <wsdl:portType name=“MdpServiceSoap”>
        <wsdl:operation name=“GetPackage”>
          <documentation
    xmlns=“http://schemas.xmlsoap.org/wsdl/”>GetPackage for Mdp
    Services</documentation>
          <wsdl:input message=“tns:GetPackageSoapIn” />
          <wsdl:output message=“tns:GetPackageSoapOut” />
        </wsdl:operation>
        <wsdl:operation name=“GetSecurityToken”>
          <documentation xmlns=“http://schemas.xmlsoap.org/wsdl/”>Returns
    the security token for the session.</documentation>
          <wsdl:input message=“tns:GetSecurityTokenSoapIn” />
          <wsdl:output message=“tns:GetSecurityTokenSoapOut” />
        </wsdl:operation>
      </wsdl:portType>
      <wsdl:binding name=“MdpServiceSoap” type=“tns:MdpServiceSoap”>
        <soap:binding transport=“http://schemas.xmlsoap.org/soap/http”
    style=“document” />
        <wsdl:operation name=“GetPackage”>
          <soap:operation
    soapAction=“http://www.microsoft.com/WindowsMedia/MDP/2005/10/10/Core
    /GetPackage” style=“document” />
          <wsdl:input>
            <soap:body use=“literal” />
            <soap:header message=“tns:GetPackageMdpHeader”
    part=“MdpHeader” use=“literal” />
          </wsdl:input>
          <wsdl:output>
            <soap:body use=“literal” />
          </wsdl:output>
        </wsdl:operation>
        <wsdl:operation name=“GetSecurityToken”>
          <soap:operation
    soapAction=“http://www.microsoft.com/WindowsMedia/MDP/2005/10/10/Core
    /GetSecurityToken” style=“document” />
          <wsdl:input>
            <soap:body use=“literal” />
            <soap:header message=“tns:GetSecurityTokenMdpHeader”
    part=“MdpHeader” use=“literal” />
          </wsdl:input>
          <wsdl:output>
            <soap:body use=“literal” />
            <soap:header message=“tns:GetSecurityTokenMdpReturnHeader”
    part=“MdpReturnHeader” use=“literal” />
          </wsdl:output>
        </wsdl:operation>
      </wsdl:binding>
      <wsdl:service name=“MdpService”>
        <documentation xmlns=“http://schemas.xmlsoap.org/wsdl/”>Mdp Web
    Service</documentation>
        <wsdl:port name=“MdpServiceSoap” binding=“tns:MdpServiceSoap”>
          <soap:address location=“http://shusakmain/mdp/mdpservice.asmx”
    />
        </wsdl:port>
      </wsdl:service>
    </wsdl:definitions>
```

### Appendix C

MDP Core

The MDP Core is composed of several different items which web services can use for implementing functionality.

The MDP Core is delivered in a single DLL called:
WindowsMedia.Services.Platform.Apps.Mdp.Core.dll

Any web service intending to use MDP will specify it by adding it the project's REFERENCES section in the SOURCES file for the project and then add a using statement to the code to use it within there.

Each object and its function are described in the following sections.

MdpHeader Class & MdpParameterKeyAttribute Class

The MdpHeader class is a derived from the SoapHeader class. This comnmon header is passed to all web methods using the standard NET mechanism for passing a Soap header.

The MdpHeader is part of the protocol for MDP. It is expected as a SOAP header and will be validated on each MDP transaction. Fields will be type-checked during SOAP de-serialization. After the header has been de-serialized into the MdpHeader object, each field in turn will be validated to determine if the data is correct for the implementing service. If the header fields are not valid a MdpException will occur. The MdpException will contain information on the field that is invalid. This information will purposely be vague for security reasons.

After the MdpHeader fields are valid, they will be inserted into the MdpParameterCollection object as parameters available to the web service. In addition, all MdpHeader fields will be logged to the IIS Log. Since there may be a limit to what can be logged, these parameters do have precedence over ad-hoc logging of other parameters.

In the MDP Core, the MdpHeader will be a class that provides read-only properties for each setting. There is no reason to have write access to these properties as the MdpHeader is not returned on the client response.

It should be noted that the MdpHeader object is available to each WebMethod via the RequestHeader public property contained with the MdpWebService base class.

On the web service side this class will contain internal methods for validation and logging of the parameters as required.

MdpReturnHeader Class

The MdpReturnHeader class is a class derived from the SoapHeader class. This common header is passed back to clients on the GetSecurityToken( ) call. Within this header is the security token that is expected to be used on subsequent calls. This value is only valid on a secure session. Web Service implementations of MDP will not knowingly use this header in any way. It will only be used if the service has indicated that there is to be a secure exchange through the MdpExtension Attribute class and the client has requested this through the GetSecurityToken( ) web method over a secure channel. The validation of the incoming header will expect the security token when a web method is marked secure.

MdpExtensionAttribute Class

The MdpExtensionAttribute class is derived from the SoapExtensionAttribute class. The MdpExtensionAttribute class is used by the web methods using MDP to communicate high-level requirements to the MDP SoapExtension. The MdpExtensionAttribute class takes the following as input to set properties for the behavior of the MDP SoapExtension:

| Attribute Argument | Type | Description |
|---|---|---|
| ServiceName | String | (required) name of the |
| | | service using for logging |
| | | and for counter increments |
| LogMemberName | String | (required) name of the class |
| | | member that will contain |
| | | an instance of the logging |
| | | object |
| Logging | MDP_LOG_TYPES | types of logging that should |
| | enumeration value | be performed (IIS, |
| | | UnifiedLogging) |
| Secure | Boolean | true if security is required |
| | | for this service, false |
| | | otherwise |
| SecurityToken | Boolean | True if security token is |
| | | required to be valid, false |
| | | otherwise |
| MxfSchema | String | File name of the web |
| | | method's MXF schema file |

The MdpExtensionAttribute class sets the attributes for a specific web method to signal to the underlying MdpSoapExtension instance specific requirement needs for the service.

ServiceName is required and is used in logging calls, counters, etc. The service name is something that should be readable, yet short and concise if possible. The ServiceName is used also to look up configuration information in the MDP.XML configuration file. If there is a mismatch, configuration information will default to the MDP Core settings.

The LogMemberName is a string that matches an instance variable in the derived class. During runtime, reflection is used to set the class member with this name to the specific instance of the MdpLog object setup by the MdpSoapExtension.

The logging parameter signifies to the extension that if logging should occur and to what type of logging is needed. This is an enumeration available in MDP Core that specifies what types of logging should occur for the parameters. LOG_TYPE_IIS specifies that parameters are logged via the query string to the IIS log. LOG_TYPE_UNIFIEDLOG specifies that logging should occur to the vNext unified log. These can be combined to have logging occur to both. The default value for this setting is LOG_NONE.

The Secure parameter signifies the method is to be handled over a secure connection only. The underlying transport in this case will be HTTPS. The service will verify that it is being accessed in such a manner. The default value for this is false.

The SecurityToken parameter specifies that the method should only be called if the SecurityToken in the header is required to be valid. This signifies to the MdpSoapExtension to validate this explicity. The default value for this is false.

The MxfSchema parameter is the file name and path to the schema of the MXF format that is returned by the attributed web method. When specified this is loaded and used to validate the MXF before SOAP serialization occurs. In the case of a validation error a MxfSchemaValidation exception will be thrown.

It should be noted that additional attributes can be added later without breaking compatibility with existing code to facilitate additional functionality. This is all done with this class. The attribute declaration on the Web Method then changes for any additions. Also the order of the parameters after the initial required ServiceName can be specified in any order using the standard .NET methods of specifying values for attributes.

Mdp WebService Abstract Class

The MdpWebService class is derived from NET WebService class. This class is marked abstract and contains one method that must be overridden.

public abstract XmlNode GetPackage(string packageName, string version,
MdpParameterCollection parameters);

The GetPackage interface is the basis for an MDP web service. When overridden in an implementation this is the method responsible for returning the data in MXF format. The input to this function will be a string containing the name of the package requested and the current version of the associated package on the client. The MdpParameterCollection class is a key-value-pair array of parameters to the web method. The MdpParameterCollection class provides methods and properties for maintaining the data within. This method is the basis for the MDP transaction and thus, each service will perform its individual logic here.

The return should always be MXF format. An XSD validation on the return before SOAP serialization across the wire to check the validity of the MXF schema can occur if the MxfSchema attribute is set (or overridden in config) on the MdpExtensionAttribute class.

The second web method the MdpWebService class provides is GetSecurityToken( ):
public void GetSecurityToken(string clientAuthToken)

This web method is called over a secure HTTPS connection passing in the common MdpHeader along with a string that is the client's authentication token. The web method will return the security token within the MdpResponseHeader.

MdpParameterCollection Class

The MdpParameterCollection class is an encapsulation around a .NET framework collection class to work around the limitations of the NET Framework's lack of Xml Serialization support for objects inheriting from IDictionary. The MdpParameterCollection class contains several methods, properties and an internal MdpParameter class to handle the key/value pairs of parameters that may be passed into the GetPackage( ) web method. All keys and values are represented as strings. It is up to the implementers to cast to appropriate types from this collection.

This class handles the serialization/deserialization through several methods and properties as well as providing a convenient set of methods for dealing with the collection in a standard .NET manner.

The MdpParameter class internal to the MdpParameterCollection class holds the key/value pairs for an individual setting. It contains a constructor which takes a DictionaryEntry object to initialize the member variables, Key and Value.

The MdpParameterCollection class then contains a property MdpParameters which returns an array of MdpParameter objects. It is with this property (the get & set methods) as well as the internal MdpParameter class that allows the elements of the internal non-serializable collection to actually be serialized.

MdpSoapExtension Class

The MdpSoapExtension class is derived from SoapExtension. This contains the required overridden methods to make it a SoapExtension. It is within this class that logging, security and validation occur before serialization and after deserialization.

The ProcessMessage method is called at all Soap Message stages. It is here in which MDP hooks into the communication to validate parameters before they reach the derived web service. Also MXF Schema validation will be performed here before data is sent across the wire. This will happen before serialization is to occur.

Logging is automatic for parameters passed through the headers and parameter collections. When logging is specified each parameters is put into a logging delimeter. These are delineated by names:
MdpHeader=name value pairs of the MdpHeader fields
PackageName=the package name parameter value
Version=the version parameter value
MdpParams=name value pairs from the MdpParameterCollection
   Mdp Validation Config Class

The MdpValidationConfig class holds the parameter validation settings as read from the configuration and is internal to MDP. It collects the settings from the configuration for the core settings then overwrites those settings by service specific settings as necessary. Internal to this class is a MdpParameterConfig object class which holds settings specific to each parameter.

Mdp Exceptions

There are several areas where exceptions are returned to the client. The Mdp Exception classes encapsulate the individual exceptions. The Mdp Exceptions will be derived from standard NET Framework exceptions. Any exceptions that are returned to the client will be derived from the standard SoapException. Exceptions that are to be returned to the web service code will be derived from standard NET exceptions. Each exception overrides the StackTrace property returning string.Empty to avoid returning too much information to the client regarding the exception.

Configuration

The MDP.XML file contains the configurable items for Mdp. This file is based on the schema located in MDP.XSD and plugs into the vNext configuration system. For the base Mdp implementation, two sections are important, <MdpCoreSettings> and <MdpSecurity>. The remaining sections are defmed as <ServiceName> (where ServiceName is the same name passed in via the MdpExtensionAttribute on the web method) and contain settings specific to the service implementation. Some items in the <ServiceName> sections override the settings contained in the <MdpCoreSettings> section. Each <ServiceName> section provides the information for the parameters for Mdp validation. For Mdp to function correctly for a service, the implementer must define all the parameters (required or optional) with the regular expressions for the parameters as well as the regular expressions for the PackageName and PackageVersion parameters.

For <MdpCoreSettings> the following are required:
<HeaderValidation> section containing the following:
   <ValidClientTypes>—regular expression defining what client types are allowed
   <ValidClientVersions>—regular expression defining what client versions are allowed
   <ValidClientlds>—regular expression for the format of a client id (GUID)
   <ValidCountryCodes>—regular expression for defining the country codes allowed
   <ValidLanguageIds>—regular expression for defining the language ids allowed
   <ValidTestKeys>—regular expression for defining the test key format
   <ValidTimezones>—regular expression for defining the timezone format
   <ValidOems>—regular expression for defining the Oem format
   <ValidOemModels>—regular expression for defining the OemModel format
   <ValidSecurityToken>—regular expression for defining the format of a security token
<ValidClientAuthenticationToken>—regular expression for defining the format of the client authentication token
<SecurityTokenExpiration>—timespan for the expiration offset of a security token
<ServiceHost>—the generic service host port for MDP
<AuthFile>—(0 or more)—the RSA key file locations for the client types

The MdpSecurity section is optional however currently defines the CounterName for GetSecurityToken( ) Invocations.

Each subsequent section then is a service's specific settings. For more information regarding a service's specific settings, please see the spec for that service. Each service however can override the header validation settings. This is done via the <ParameterValidation> element. These are read during the initialization step of the MdpSoapExtension and read into the MdpValidationConfig class.

The <ParameterValidation> element can include the following:
<ValidClientTypes>—regular expression defining what client types are allowed for this service
<ValidClientVersions>—regular expression defining what client versions are allowed for this service
<ValidCountryCodes>—regular expression for defining the country codes allowed for this service
<ValidLanguagelds>—regular expression for defining the language ids allowed for this service
<ValidTestKeys>—regular expression for defining the test keys allowed for this service
<ValidTimezones>—regular expression for defining the timezones allowed for this service
<ValidOems>—regular expression for defining the Oems allowed for this service
<ValidOemModels>—regular expression for defining the OemModels for this service
<PackageName>—regular expression for defining the PackageName allowed for this service
<PackageVersion>—regular expression for defining the PackageVersion allowed for this service
MdpParameter—(0 or more)—defines the additional parameters as passed in the MdpParameterCollection that the service expects. These are specified with the attribute “name” along with the regular expression for validating the value. In addition, two addition attributes can be supplied, “case” which specifies if the regular expression should be case sensitive or not; and “required” which specifies if the parameter is required.

Other settings common to all services include:
<LogOverride>—allows a service to override the log setting that was specified via the MdpExtensionAttribute class on the web method.
<MxfSchemaPathOverride>—allows a service to override the MxfSchema attribute that was specified via the MdpExtensionAttribute class on the web method.
<CounterName>—specifies the name of a performance counter associated with the web method. This is used when the logging type has the MDP_LOG_TYPE_COUNTER bit set.

### Appendix D

Web Service Implementation using MDP

The following code is a simple web service implementing MDP. The following code shows what is overloaded and how to set the attributes for to enable MDP. This sample code called the ParameterEcho service simply takes a set of parameters in and returns those parameters back.

To generate a web service using MDP the following is needed:
1. Web.Config file
2. ASMX file
3. Source code file (the one implementing the MdpWebService)
   Web.config

This is a normal web.config file. The only requirement for this file is that the webservices section should be the following:

```
<webServices>
    <protocols>
        <remove name=“HttpGet” />
          <remove name=“HttpPost” />
          <add name=“HttpSoap”/>
          <remove name=“Documentation” />
    </protocols>
</webServices>
```

SOAP should be the only supported protocol.
ASMX File (ParameterEcho.asmx)

This is the ASP.NET ASMX file that is hosted by IIS. There is typically one line in this file similar to the following:

<%@ WebService Language=“c#”
Class=“Microsoft.WindowsMedia.Services.Platform.Apps.Mdp.-
ParameterEcho.ParameterEchoService” %>

Source Code File (ParameterEcho.cs)

This is the file that implements the web method GetPackageo after deriving the class from MdpWebService. The bolded portions show the specific items that are needed for MDP in this case and the items that are used from MDP.

```
//**********************************************************
************
//
// Microsoft Windows Media Information Services
// Copyright (C) Microsoft Corporation. All rights reserved.
//
//**********************************************************
***********
using System;
using System.Collections;
using System.Collections.Specialized;
using System.Xml;
using System.Web.Services;
using System.Web.Services.Protocols;
using Microsoft.WindowsMedia.Services.Platform.Apps.Mdp.Core;
namespace
Microsoft.WindowsMedia.Services.Platform.Apps.Mdp.ParameterEcho
{
    public class ParameterEchoService : MdpWebService
    {
        public ParameterEchoService ( )
        {
        }
        [MdpExtension(“ParameterEcho”, “MdpLog”,
Logging=LOG_TYPE_ISS)]
        [SoapHeader(“RequestHeader”,
Direction=SoapHeaderDirection.In)]
        [WebMethod(Description=“GetPackage for
ParameterEchoService”)]
        public override XmlNode GetPackage(string version,
MdpParameterCollection parameters)
        {
            string p = string.Empty;
            foreach (DictionaryEntry e in parameters)
            {
                p = string.Format(“{0}<param name=\”{1}\“
value=\”{2}\“/>”, p, e.Key, e.Value.ToString( ));
            }
            XmlDocument mxf = new XmlDocument( );
            mxf.LoadXml(string.Format(“<MXF>{0}</MXF>”, p));
            return mxf.DocumentElement;
        }
    }
}
```

Points of Interest:
the ParameterEchoService derives from MdpWebService
the GetPackageo webmethod is overridden
the MdpExtension attribute is applied to the GetPackageo method and is specifying the name of the service along with the optional logging attribute set to IIS logging. It also specifies the MdpLog property that exists in the base class for setting the log object during runtime.
The SoapHeader declaration is included (RequestHeader)
The enumerator is used to access the internal collection of key/value pairs
   Client Implementation using MDP

The client side of MDP requires the MDP proxy and then the logic that uses the proxy. The most important property in the proxy is the Url property. In order to use different MDP web services, this Url needs to change to the location of that service.

The following code is the client side code for the ParameterEchoService:

```
//**********************************************************
**********
//
// Microsoft Windows Media Internet Services
// Copyright (C) Microsoft Corporation. All rights reserved.
//
//**********************************************************
**********
using System;
using System.Xml;
using System.IO;
using System.Collections;
using System.Web.Services.Protocols;
namespace
Microsoft.WindowsMedia.Services.Platform.Apps.Mdp.Test
{
    public class TestClient
    {
        [STAThread]
        static void Main(string[ ] args)
        {
            MdpService mdp = new MdpService( );
            mdp.Url =
“http://shusakmain/mdp/ParameterEcho.asmx”;
            Hashtable p = new Hashtable( );
            p.Add(“Test1”, “1”);
            p.Add(“Test2”, “2”);
            p.Add(“Test3”, “3”);
            p.Add(“Test4”, “4”);
            p.Add(“Test5”, “5”);
            MdpParameterCollection parameters = new
MdpParameterCollection( );
            MdpParameter [ ] items = new
MdpParameter[p.Keys.Count];
            int i = 0;
            foreach (System.Collections.DictionaryEntry de in
p)
            {
                MdpParameter item = new MdpParameter( );
                item.Key = de.Key;
                item.Value = de.Value;
                items[i++] = item;
            }
            parameters.MdpParameters = items;
            Console.WriteLine(“Calling web method...”);
            XmlNode mxf = mdp.GetPackage(“version”,
parameters);
            if (null != mxf)
                Console.WriteLine(“MXF returned:\n\n{0}”,
mxf.OuterXml);
            else
                Console.WriteLine(“No MXF returned!”);
        }
    }
}
```

### MANIFEST FILE EXAMPLES

```
<?xml version=“1.0” encoding=“UTF-8” standalone=“no”?>
<Package name=“SportsTemplate” encryptionByPDS=“true”
xmlns:xsi=“http://www.w3.org/2001/XMLSchema-instance”
xsi:noNamespaceSchemaLocation=“PDSManifest.xsd”>
  <!-- no filters set -->
  <PackageFile fileName=“SportsTemplateALL1-2.0-4.0-ALL-
20050505.cab” attachmentName=“SportsAttachment1”
availableVersion=“1.0” />
  <PackageFile fileName=“SportsTemplateALL2-2.0-4.0-ALL-
20050505.cab” attachmentName=“SportsAttachment2”
availableVersion=“1.0” />
  <!-- one filter set -->
  <Filter name=“OEM” value=“foo”>
    <PackageFile fileName=“SportsTemplate-2.0-4.0-foo-20050505.cab”
attachmentName=“SportsAttachment3” availableVersion=“2.0” />
  </Filter>
  <!-- two filters set -->
  <Filter name=“OEM” value=“Dell”>
    <Filter name=“CountryCode” value=“US”>
      <PackageFile fileName=“SportsTemplateUS-2.0-4.0-foo-
20050505.cab” attachmentName=“SportsAttachment4”
availableVersion=“2.0” />
    </Filter>
  </Filter>
  <!-- three filters set -->
  <Filter name=“OEM” value=“*”>
    <Filter name=“CountryCode” value=“ZZ”>
      <Filter name=“ClientVersion” value=“Diamond”>
        <PackageFile fileName=“SportsTemplateZZ-2.0-4.0-ALL-
20050505.cab” attachmentName=“SportsAttachment5”
availableVersion=“1.0” />
      </Filter>
    </Filter>
  </Filter>
  <!-- one top level filter, multiple sub filters set -->
  <Filter name=“OEM” value=“*”>
    <Filter name=“CountryCode” value=“US, CA”>
      <Filter name=“ClientVersion” value=“Diamond”>
        <PackageFile fileName=“SportsTemplateUSCAdiamd-2.0-4.0-
ALL-20050505.cab” attachmentName=“SportsAttachment6”
availableVersion=“3.0” />
      </Filter>
      <PackageFile fileName=“SportsTemplateUSCA-2.0-4.0-ALL-
20050505.cab” attachmentName=“SportsAttachment7”
availableVersion=“2.0” />
    </Filter>
    <Filter name=“CountryCode” value=“MX”>
      <PackageFile fileName=“SportsTemplateMX-2.0-4.0-ALL-
20050505.cab” attachmentName=“SportsAttachment8”
availableVersion=“2.0” />
      <Filter name=“OEM” value=“HP”>
        <PackageFile fileName=“SportsTemplateMX1-2.0-4.0-HP-
20050505.cab” attachmentName=“SportsAttachment9”
availableVersion=“2.0” />
        <PackageFile fileName=“SportsTemplateMX2-2.0-4.0-HP-
20050505.cab” attachmentName=“SportsAttachment10”
availableVersion=“2.0” />
      </Filter>
      <Filter name=“OEM” value=“*”>
        <PackageFile fileName=“SportsTemplateMX2-2.0-4.0-ALL-
20050505.cab” attachmentName=“SportsAttachment11”
availableVersion=“2.0” />
      </Filter>
    </Filter>
  </Filter>
  <!-- more likely filtering example -->
  <PackageFile fileName=“SportsTemplateALL3-2.0-4.0-ALL-
20050505.cab” attachmentName=“SportsAttachment12”
availableVersion=“2.0” />
  <Filter name=“OEM” value=“Dell”>
    <Filter name=“CountryCode” value=“US, CA”>
      <Filter name=“ClientVersion” value=“Diamond”>
        <PackageFile fileName=“SportsTemplateUSCA3-2.0-4.0-DELL-
20050505.cab” attachmentName=“SportsAttachment13”
availableVersion=“2.0” />
      </Filter>
    </Filter>
    <Filter name=“CountryCode” value=“UK”>
      <Filter name=“ClientVersion” value=“Diamond”>
        <PackageFile fileName=“SportsTemplateUK3-2.0-4.0-DELL-
20050505.cab” attachmentName=“SportsAttachment14”
availableVersion=“2.0” />
      </Filter>
    </Filter>
    <Filter name=“CountryCode” value=“*”>
      <Filter name=“ClientVersion” value=“Diamond”>
        <PackageFile fileName=“SportsTemplate3-2.0-4.0-DELL-
20050505.cab” attachmentName=“SportsAttachment15”
availableVersion=“2.0” />
      </Filter>
    </Filter>
  </Filter>
  <Filter name=“OEM” value=“HP”>
    <Filter narne=“CountryCode” value=“US, CA”>
      <Filter name=“ClientVersion” value=“Diamond”>
        <PackageFile fileName=“SportsTemplateUSCA3-2.0-4.0-HP-
20050505.cab” attachmentName=“SportsAttachment16”
availableVersion=“2.0” />
      </Filter>
    </Filter>
    <Filter name=“CountryCode” value=“UK”>
      <Filter name=“ClientVersion” value=“Diamond”>
        <PackageFile fileName=“SportsTemplateUK3-2.0-4.0-HP-
20050505.cab” attachmentName=“SportsAttachment17”
availableVersion=“2.0” />
      </Filter>
    </Filter>
    <Filter name=“CountryCode” value=“*”>
      <Filter name=“ClientVersion” value=“Diamond”>
        <PackageFile fileName=“SportsTemplate3-2.0-4.0-HP-
20050505.cab” attachmentName=“SportsAttachment18”
availableVersion=“2.0” />
      </Filter>
    </Filter>
  </Filter>
  <Filter name=“OEM” value=“*”>
    <Filter name=“CountryCode” value=“US,CA”>
      <Filter name=“ClientVersion” value=“Diamond”>
        <PackageFile fileName=“SportsTemplateUSCA3-2.0-4.0-ALL-
20050505.cab” attachmentName=“SportsAttachment19”
availableVersion=“2.0” />
      </Filter>
    </Filter>
    <Filter name=“CountryCode” value=“UK”>
      <Filter name=“ClientVersion” value=“Diamond”>
        <PackageFile fileName=“SportsTemplateUK3-2.0-4.0-ALL-
20050505.cab” attachmentName=“SportsAttachment20”
availableVersion=“2.0” />
      </Filter>
    </Filter>
    <Filter name=“CountryCode” value=“*”>
      <Filter name=“ClientVersion” value=“Diamond”>
        <PackageFile fileName=“SportsTemplate3-2.0-4.0-ALL-
20050505.cab” attachmentName=“SportsAttachment21”
availableVersion=“2.0” />
      </Filter>
    </Filter>
  </Filter>
</Package>
```

### Example 1

MXF—Directory Service

```
<MXF version=”1.0”>
    <Assembly name=”mcstore.dll” version=”6.0.5045.0”>
        <NameSpace name=”Microsoft.MediaCenter.Store”>
            <Type name=“StoredObject”/>
            <Type name=“Provider”/>
            <Type name=”UId” parentFieldName=”target”/>
            <Type name=”Package”/>
            <Type name=”PackageDeliveryService/>
            <Type name=”WebServiceLocator”/>
        </NameSpace>
    </Assembly>
    <Provider id=“WMIS”>
        <UId>!Microsoft.MediaCenter.ProviderNames!WMIS</UId>
    </Provider>
    <StoredObjects provider=”WMIS”>
        <WebServiceLocators>
            <WebServiceLocator id=”MDP CAB” protocol=”MDP”
                url=”http://somewhere.com/CABs”/>
            <WebServiceLocator id=”Guide Listings”
                  protocol=”MDP”
                  url=”http://epg.microsoft.com/Listings”/>
            <WebServiceLocator protocol=”Sports WebService”
                  url=”http://fsn.com/SportsData”>
                <UId>|Microsoft.MediaCenter.WebServices|Sports
                Live</UId>
            </WebServiceLocator>
        </WebServiceLocators>
        <Packages>
            <Package id=”Directory Service” >
                <UId nameSpace=”WMIS.Packages”
            value=”Directory Service”>
            </Package>
            <Package id=”Headends” availableVersion=”1234”>
                <UId nameSpace=”WMIS.Packages”
            value=”Headends”>
            </Package>
            <Package id=”ATSC Listings” >
                <UId nameSpace=”WMIS.Packages” value=”ATSC
            Listings”>
            </Package>
            <Package id=”Locale Updates” availableVersion=”1”>
                <UId nameSpace=”WMIS.Packages” value=”Locale
            Updates”>
            </Package>
            <Package id=”Sports Listings”
            availableVersion=”2005-04-23”>
                <UId nameSpace=”WMIS.Packages” value=”Sports
            Listings”>
            </Package>
        </Packages>
        <PackageDeliveryServices nextTimeLength=”60m”
              failureWait=”24h” retryCount=”3”
              minRetryWait=”10m” maxRetryWait=”1h”>
            <PackageDeliveryService package=”Directory Service”
                  webServiceLocator=”MDP CAB” expires=”2006-
                  12-31” nextTime=”2005-05-03T04:00”>
                <parameters>
                    <KeyValue key=”Region”/>
                    <KeyValue key=”PostalCode”/>
                </parameters>
            </PackageDeliveryService>
            <PackageDeliveryService package=”Headends”
                  webServiceLocator=”MDP CAB” expires=”2006-
                  12-31” nextTime=”2005-05-03T04:00”>
                <parameters>
                    <KeyValue key=”Region”/>
                    <KeyValue key=”PostalCode”/>
                </parameters>
            </PackageDeliveryService>
            <PackageDeliveryService package=”ATSC Listings”
                  webServiceLocator=”Guide Listings”
                  expires=”2006-12-31” nextTime=”2005-05-
                  03T04:00”>
                <parameters>
                    <KeyValue key=”Region”/>
                    <KeyValue key=”PostalCode”/>
                </parameters>
            </PackageDeliveryService>
            <PackageDeliveryService package=”Locale Updates”
                  webServiceLocator=”MDP CAB” expires=”2006-
                  12-31” nextTime=”2005-05-03T04:00”/>
            </PackageDeliveryService>
            <PackageDeliveryService package=”Sports Listings”>
                <parameters>
                    <KeyValue key=”Region”/>
                    <KeyValue key=”PostalCode”/>
                </parameters>
            </PackageDeliveryService>
        </PackageDeliveryServices>
    </StoredObjects>
</MXF>
```

### Appendix E

Directory Service Database Schema

The following databases will be created for the Directory Service:

| Stage Name | Database Name | Comments |
|---|---|---|
| dls_DirectoryService | dis_DirectoryService | Content loaded from |
| | | the Xml file |
| pcs_DirectoryService | pcs_DirectoryService | Content |
| | | replicated from |
| | | dls_DirectoryService |
| pas_DirectoryService | pas_DirectoryServiceA | Attach DB file from |
| | pas_DirectoryServiceB | pcs_DirectoryService |
| | | Only one of the DB is |
| | | available at a time |

All the above databases will have identical schema as the following diagram

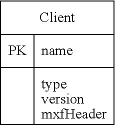

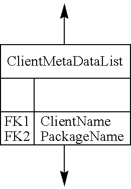

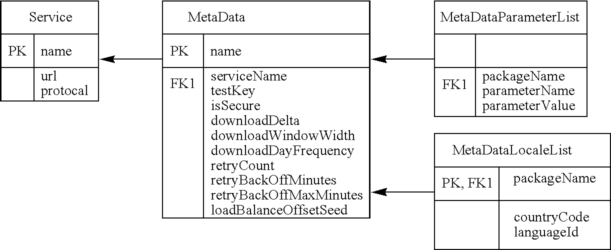

TABLE
[Client]

| Column | | Allow | |
|---|---|---|---|
| Name | Data Type | Null | Description |
| name | varchar(50) | No | Unique name of the client used |
| | | | internally by Directory Service. |
| | | | For example “eHome 1.0” |
| type | varchar(50) | No | Client type. |
| | | | For example “eHome” |
| version | varchar(50) | No | Client version |
| | | | For example “1.0” |
| mxfHeader | varchar(2000) | Yes | The static MXF header |

TABLE
[Service]

| Column | | Allow | |
|---|---|---|---|
| Name | Data Type | Null | Description |
| name | varchar(50) | No | Unique name of the service. |
| | | | Will be returned to the client as id of |
| | | | the <WebServiceLocator>. |
| url | nvarchar(250) | No | |
| protocol | Varchar(50) | No | |

TABLE
[Metadata]

| Column Name | Data Type | Allow Null | Description |
|---|---|---|---|
| name | varchar(50) | No | Unique name of the meta data. |
| | | | Will be returned to the client as id of the |
| | | | <Package> if the type of meta data is set to |
| | | | “Package” |
| serviceName | Varchar(50) | No | Refer to the name column in the Service table |
| | | | as foreign key. |
| testKey | varchar(50) | Yes | Service key for test |
| | | | For example “EPG Test” |
| isSecurity | tinyInt | No | Indicates if security token is required |
| downloadWindowWidth | varchar(50) | Yes | Client download window duration |
| | | | less than (24 hours/downloadDayFreqfeuncy) |
| downloadDelta | varchar(50) | Yes | Duration in full days, the client should wait |
| | | | between downloads |
| donwloadDayFrequency | tinyInt | Yes | How many times the package should be |
| | | | downloaded within a day. |
| | | | For example: |
| | | | Sport package need to be downloaded 2 times |
| | | | a day. |
| | | | This number will be used to calculate refresh |
| | | | interval. |
| loadBalanceOffsetSeed | Varchar(50) | Yes | Used by the load balance algorithm to pick the |
| | | | start time of the download window. |
| retryCount | Int | Yes | Number of times the client should retry to get |
| | | | the data from a service in the event of failure. |
| retryBackOffMin | varchar(50) | Yes | Minimum duration the client should wait |
| | | | between retries |
| retryBackOffMax | varchar(50) | Yes | Maximum duration the client should wait |
| | | | between retries |

TABLE
[MetadataLocaleMap]

| Column Name | Data Type | Allow Null | Description |
|---|---|---|---|
| metaDataName | varchar(50) | No | Refer to the name |
| | | | column in the Package table |
| | | | as foreign key. |
| countryCode | char(2) | No | 2 character country code |
| languageId | Char(3) | No | |

TABLE
[MetadataParameterList]

| | | Allow | |
|---|---|---|---|
| Column Name | Data Type | Null | Description |
| metaDataName | varchar(50) | No | Refer to the name column |
| | | | in the Package table as |
| | | | foreign key. |
| parameterName | varchar(50) | No | Name of the parameter |
| parameterValue | varchar(50) | Yes | Value of the parameter, can be |
| | | | empty |

TABLE
[ClientMetadataList]

| | | Allow | |
|---|---|---|---|
| Column Name | Data Type | Null | Description |
| clientName | varchar(50) | No | Refer to the name column in the |
| | | | Client table as foreign key. |
| metaDataName | varchar(50) | No | Refer to the name column |
| | | | in the Package table as |
| | | | foreign key. |

### Appendix F

A sample file that defines available services and schedule information is shown below.

```
<?xml version=“1.0” encoding=“utf-8” ?>
<DirectoryService>
<ServiceList>
<Service name=“Directory Service” protocol=“MDP”
    url=“https://preview.data.tvdownload.microsoft.com/Directory/
    DirectoryService.asmx”>
<MetaData name=“Directory” testKey=“” type=“Package” isSecure=“true”
    dataVersion=“20050815.1200”>
<DownloadInfo>
  <Schedule clientDownloadDelta=“P1D” clientDownloadFrequency=“1”
    clientDownloadWindowWidth=“PT1H” loadBalanceOffsetSeed=“PT1H” />
  <Retry maxCount=“3” backOffMin=“PT5M” backOffMax=“PT15M” />
<ParameterList>
  <Parameter name=“PreferredDownloadStartTime” />
  <Parameter name=“PreferredDownloadDuration” />
    </ParameterList>
    </DownloadInfo>
<Globalization>
  <Locale countryCode=“*” languageId=“*” />
    </Globalization>
    </MetaData>
    </Service>
<Service name=“Package Delivery Service” protocol=“MDP”
      url=“https://preview.data.tvdownload.microsoft.com/packagedelivery/
      PackageDelivery.asmx”>
<MetaData name=“SportsTemplate” testKey=“SportsNut” type=“Package”
    isSecure=“true”>
<DownloadInfo>
  <Schedule clientDownloadDelta=“P1D” clientDownloadFrequency=“1”
    clientDownloadWindowWidth=“PT1H” loadBalanceOffsetSeed=“PT1H” />
  <Retry maxCount=“3” backOffMin=“PT5M” backOffMax=“PT15M” />
    </DownloadInfo>
<Globalization>
  <Locale countryCode=“us” languageId=“en” />
    </Globalization>
    </MetaData>
<MetaData name=“SportsSchedule” testKey=“SportsNut” type=“Package”
    isSecure=“true”>
<DownloadInfo>
  <Schedule clientDownloadDelta=“P1D” clientDownloadFrequency=“2”
    clientDownloadWindowWidth=“PT1H” loadBalanceOffsetSeed=“PT1H” />
  <Retry maxCount=“3” backOffMin=“PT5M” backOffMax=“PT15M” />
    </DownloadInfo>
<Globalization>
  <Locale countryCode=“us” languageId=“en” />
    </Globalization>
    </MetaData>
<MetaData name=“ClientUpdate” testKey=“” type=“Package”
    isSecure=“true”>
<DownloadInfo>
  <Schedule clientDownloadDelta=“P1D” clientDownloadFrequency=“1”
    clientDownloadWindowWidth=“PT1H” loadBalanceOffsetSeed=“PT1H” />
  <Retry maxCount=“3” backOffMin=“PT5M” backOffMax=“PT15M” />
    </DownloadInfo>
<Globalization>
  <Locale countryCode=“*” languageId=“*” />
    </Globalization>
    </MetaData>
    </Service>
<Service name=“Discovery Service” protocol=“MDP”
    url=“https://preview.data.tvdownload.microsoft.com/discovery/
    DiscoveryService.asmx”>
<MetaData name=“Discovery” testKey=“” type=“Package” isSecure=“true”>
<DownloadInfo>
  <Schedule clientDownloadDelta=“P1D” clientDownloadFrequency=“1”
    clientDownloadWindowWidth=“PT1H” loadBalanceOffsetSeed=“PT1H” />
  <Retry maxCount=“3” backOffMin=“PT5M” backOffMax=“PT15M” />
    </DownloadInfo>
<Globalization>
  <Locale countryCode=“*” languageId=“*” />
    </Globalization>
    </MetaData>
    </Service>
    </ServiceList>
<ClientList>
<Client name=“ehome 6.0” type=“ehome” version=“6.0”>
<AvailableMetaDataList>
  <AvailableMetaData name=“Directory” />
  <AvailableMetaData name=“SportsTemplate” />
  <AvailableMetaData name=“SportsSchedule” />
  <AvailableMetaData name=“ClientUpdate” />
  <AvailableMetaData name=“Discovery” />
    </AvailableMetaDataList>
  <MXFHeader>
  - <![CDATA[
  <MXF version=“1.0”><Assembly name=“mcstore”><NameSpace
    name=“Microsoft.MediaCenter.Store”><Type name=“Provider”/><Type
    name=“UId” parentFieldName=“target”/><Type name=“Package”/><Type
    name=“PackageDeliveryInfo” /><Type
    name=“WebServiceLocator”/><NameSpace></Assembly><Provider
    id=“WMIS”><UId>!Microsoft.MediaCenter.ProviderNames!WMIS</UId></Provider
    ></MXF>
    ]]>
    </MXFHeader>
    </Client>
    </ClientList>
    </DirectoryService>
```

### Appendix G

Listed below is an exemplary schema definition for DirectoryService.xml.

```
<?xml version=“1.0” encoding=“utf-8” ?>
<xs:schema xmlns:xs=“http://www.w3.org/2001/XMLSchema”
xmlns:sql=“urn:schemas-microsoft-com:mapping-schema”>
    <xs:annotation>
        <xs:appinfo>
            <sql:relationship name=“Service_MetaData”
parent=“Service” parent-key=“name” child=“MetaData” child-
key=“serviceName” />
            <sql:relationship
name=“MetaData_DownloadScheduleInfo” parent=“MetaData” parent-
key=“name” child=“MetaDataDownloadScheduleInfo” child-
key=“metaDataName” />
            <sql:relationship name=“MetaData_DownloadRetryInfo”
parent=“MetaData” parent-key=“name”
    child=“MetaDataDownloadRetryInfo” child-key=“metaDataName” />
            <sql:relationship name=“MetaData_Locale”
parent=“MetaData” parent-key=“name” child=“MetaDataLocaleList”
child-key=“metaDataName” />
            <sql:relationship name=“MetaData_Parameter”
parent=“MetaData” parent-key=“name” child=“MetaDataParameterList”
child-key=“metaDataName” />
            <sql:relationship name=“Client_MetaData”
parent=“Client” parent-key=“name” child=“ClientMetaDataList” child-
key=“clientName” />
        </xs:appinfo>
    </xs:annotation>
    <!--string with at least one character and not leading/taling
spaces-->
    <xs:simpleType name=“NoneEmptyString”>
        <xs:restriction base=“xs:string”>
            <xs:minLength value=“1” />
            <xs:pattern value=“\S.*\S” />
            <xs:pattern value=“\S” />
        </xs:restriction>
    </xs:simpleType>
    <xs:element name=“DirectoryService” sql:is-constant=“1”>
        <xs:complexType>
            <xs:sequence>
                <xs:element ref=“ServiceList” minOccurs=“1”
maxOccurs=“1” />
                <xs:element ref=“ClientList” minOccurs=“1”
maxOccurs=“1” />
            </xs:sequence>
        </xs:complexType>
        <xs:key name=“PrimaryKeyService”>
            <xs:selector xpath=“ServiceList/Service” />
            <xs:field xpath=“@name” />
        </xs:key>
        <xs:key name=“PrimaryKeyMetaData”>
            <xs:selector xpath=“ServiceList/Service/MetaData”
/>
            <xs:field xpath=“@name” />
        </xs:key>
        <xs:key name=“PrimaryKeyClient”>
            <xs:selector xpath=“ClientList/Client” />
            <xs:field xpath=“@name” />
        </xs:key>
<!--
        <xs:keyref name=“ForeignKeyMetaData”
refer=“PrimaryKeyMetaData”>
            <xs:selector xpath=“.//AvailableMetaData” />
            <xs:field xpath=“@name” />
        </xs:keyref>
-->
    </xs:element>
    <xs:element name=“ClientList” sql:is-constant=“1”>
        <xs:complexType>
            <xs:sequence>
                <xs:element ref=“Client” minOccurs=“1”
maxOccurs=“20” />
            </xs:sequence>
        </xs:complexType>
        <xs:unique name=“UniqueClientTypeVersion”>
            <xs:selector xpath=“Client” />
            <xs:field xpath=“@type” />
            <xs:field xpath=“@version” />
        </xs:unique>
    </xs:element>
    <xs:element name=“Client” sql:relation=“Client”>
        <xs:complexType>
            <xs:sequence>
                <xs:element name=“AvailableMetaDataList”
sql:is-constant=“1” minOccurs=“1” maxOccurs=“1”>
                    <xs:complexType>
                        <xs:sequence>
                            <xs:element
name=“AvailableMetaData” sql:relation=“ClientMetaDataList”
sql:relationship=“Client_MetaData” minOccurs=“1” maxOccurs=“1000”>
                                <xs:complexType>
                                    <xs:attribute
name=“name” sql:field=“metaDataName” use=“required”>
    <xs:simpleType><xs:restriction base=“NoneEmptyString”>
    <xs:maxLength value=“50” /></xs:restriction>
    </xs:simpleType></xs:attribute></xs:complexType>
    </xs:element></xs:sequence></xs:complexType>
        <xs:unique name=“UniqueMetaDataPerClient”>
                        <xs:selector
xpath=“AvailableMetaData” />
                        <xs:field xpath=“@name” />
                </xs:unique>
    </xs:element>
            <xs:element name=“MXFHeader” sql:field=“mxfHeader”
minOccurs=“1” maxOccurs=“1”>
                    <xs:simpleType>
                        <xs:restriction base=“xs:string”>
                          <xs:maxLength value=“2000” />
                        </xs:restriction>
                    </xs:simpleType>
                </xs:element>
            </xs:sequence>
            <xs:attribute name=“name” use=“required”>
                <xs:simpleType>
                    <xs:restriction base=“NoneEmptyString”>
                        <xs:maxLength value=“50” />
                    </xs:restriction>
                </xs:simpleType>
            </xs:attribute>
            <xs:attribute name=“type” use=“required”>
                <xs:simpleType>
                    <xs:restriction base=“NoneEmptyString”>
                        <xs:maxLength value=“50” />
                    </xs:restriction>
                </xs:simpleType>
            </xs:attribute>
            <xs:attribute name=“version” use=“required”>
                <xs:simpleType>
                    <xs:restriction base=“xs:string”>
                        <xs:maxLength value=“50” />
                        <!--only the primary and the
minor version is used-->
                        <xs:pattern value=“\d+\.\d+” />
                    </xs:restriction>
                </xs:simpleType>
            </xs:attribute>
        </xs:complexType>
    </xs:element>
    <xs:element name=“ServiceList” sql:is-constant=“1”>
        <xs:complexType>
            <xs:sequence>
                <xs:element ref=“Service” minOccurs=“1”
maxOccurs=“100” />
            </xs:sequence>
        </xs:complexType>
    </xs:element>
    <xs:element name=“Service” sql:relation=“Service”>
        <xs:complexType>
            <xs:sequence>
                <xs:element ref=“MetaData” minOccurs=“1”
maxOccurs=“100” />
            </xs:sequence>
            <xs:attribute name=“name” use=“required”>
                <xs:simpleType>
                    <xs:restriction base=“NoneEmptyString”>
                        <xs:maxLength value=“50” />
                    </xs:restriction>
                </xs:simpleType>
            </xs:attribute>
            <xs:attribute name=“mxfId” use=“required”>
                <xs:simpleType>
                    <xs:restriction base=“xs:string”>
                        <xs:maxLength value=“50” />
                        <xs:pattern value=“\S+” />
                    </xs:restriction>
                </xs:simpleType>
            </xs:attribute>
            <xs:attribute name=“protocol” use=“required”>
                <xs:simpleType>
                    <xs:restriction base=“xs:NMTOKEN”>
                        <xs:enumeration value=“MDP” />
                    </xs:restriction>
                </xs:simpleType>
            </xs:attribute>
            <xs:attribute name=“url” use=“required”>
                <xs:simpleType>
                    <xs:restriction base=“NoneEmptyString”>
                        <xs:maxLength value=“250” />
                    </xs:restriction>
                </xs:simpleType>
            </xs:attribute>
        </xs:complexType>
    </xs:element>
    <xs:element name=“MetaData” sql:relation=“MetaData”
sql:relationship=“Service_MetaData”>
        <xs:complexType>
            <xs:sequence>
                <xs:element ref=“DownloadInfo” minOccurs=“0”
maxOccurs=“1” />
                <xs:element ref=“Globalization” minOccurs=“1”
maxOccurs=“1” />
            </xs:sequence>
            <xs:attribute name=“name” use=“required”>
                <xs:simpleType>
                    <xs:restriction base=“NoneEmptyString”>
                        <xs:maxLength value=“50” />
                    </xs:restriction>
                </xs:simpleType>
            </xs:attribute>
            <xs:attribute name=“mxfId” use=“required”>
                <xs:simpleType>
                    <xs:restriction base=“xs:string”>
                        <xs:maxLength value=“50” />
                        <xs:pattern value=“\S+” />
                    </xs:restriction>
                </xs:simpleType>
            </xs:attribute>
            <xs:attribute name=“testKey” use=“optional”>
                <xs:simpleType>
                    <xs:restriction base=“xs:string”>
                        <xs:maxLength value=“50” />
                    </xs:restriction>
                </xs:simpleType>
            </xs:attribute>
            <xs:attribute name=“isSecure” use=“required”
type=“xs:boolean” />
            <xs:attribute name=“type” use=“required”>
                <xs:simpleType>
                    <xs:restriction base=“xs:NMTOKEN”>
                        <xs:enumeration value=“Package”
/>
                        <xs:enumeration
value=“WebService” />
                    </xs:restriction>
                </xs:simpleType>
            </xs:attribute>
            <xs:attribute name=“dataVersion” use=“optional” >
                <xs:simpleType>
                    <xs:restriction base=“xs:string”>
                        <xs:maxLength value=“50” />
                        <xs:pattern value=“\d{8}\.\d{4}”
/>
                    </xs:restriction>
                </xs:simpleType>
            </xs:attribute>
        </xs:complexType>
    </xs:element>
    <xs:element name=“DownloadInfo” sql:is-constant=“1”>
        <xs:complexType>
            <xs:sequence>
                <xs:element name=“Schedule”
sql:relation=“MetaDataDownloadScheduleInfo”
sql:relationship=“MetaData_DownloadScheduleInfo” minOccurs=“1”
maxOccurs=“1”>
                    <xs:complexType>
                        <xs:attribute
name=“clientDownloadDelta” sql:field=“downloadDelta” use=“required”>
                            <xs:simpleType>
                    <xs:restriction base=“xs:duration”>
                    <xs:minInclusive value=“P1D”/>
                                </xs:restriction>
                            </xs:simpleType>
                        </xs:attribute>
                    <xs:attribute
name=“clientDownloadFrequency” sql:field=“downloadFrequency”
use=“required”>
                            <xs:simpleType>
                    <xs:restriction base=“xs:short”>
    <xs:minInclusive value=“1”/><xs:maxInclusive value=“10”/>
    <xs:restriction></xs:simpleType></xs:attribute>
    <xs:attribute name=“clientDownloadWindowWidth”
sql:field=“downloadWindowWidth” use=“required” >
    <xs:simpleType><xs:restriction base=“xs:duration”>
    <xs:minInclusive value=“PT1H”/><xs:maxInclusive value=“PT3H”/>
    </xs:restriction></xs:simpleType></xs:attribute>
    <xs:attribute name=“loadBalanceOffsetSeed”
sql:field=“loadBalanceOffsetSeed” use=“required” >
                            <xs:simpleType>
                                <xs:restriction
base=“xs:duration”>
                <xs:minInclusive value=“PT1M”/>
                    <xs:maxInclusive value=“PT1H”/>
                            </xs:restriction>
                        </xs:simpleType>
                        </xs:attribute>
                        </xs:complexType>
                </xs:element>
                <xs:element name=“Retry”
sql:relation=“MetaDataDownloadRetryInfo”
sql:relationship=“MetaData_DownloadRetryInfo” minOccurs=“1”
maxOccurs=“1”
                    <xs:complexType>
                <xs:attribute name=“maxCount”
sql:field=“retryCount” use=“required” >
                <xs:simpleType>
                <xs:restriction base=“xs:short”>
                    <xs:minInclusive value=“0”/>
                <xs:maxInclusive value=“10”/>
                </xs:restriction>
                </xs:simpleType>
                    </xs:attribute>
            <xs:attribute name=“backOffMin”
sql:field=“retryBackOffMin” use=“required” >
                            <xs:simpleType>
                <xs:restriction base=“xs:duration”>
            <xs:minInclusive value=“PT1M”/>
                    <xs:maxInclusive value=“PT5M”/>
                        </xs:restriction>
                        </xs:simpleType>
                        </xs:attribute>
                    <xs:attribute name=“backOffMax”
sql:field=“retryBackOffMax” use=“required” >
                    <xs:simpleType>
                    <xs:restriction base=“xs:duration”>
                    <xs:minInclusive value=“PT15M”/>
                    <xs:maxInclusive value=“PT1H”/>
</xs:restriction></xs:simpleType></xs:attribute></xs:complexType>
                </xs:element>
        <xs:element ref=“ParameterList” minOccurs=“0”
maxOccurs=“1” />
            </xs:sequence>
        </xs:complexType>
    </xs:element>
    <xs:element name=“ParameterList” sql:is-constant=“1”>
        <xs:complexType>
            <xs:sequence>
                <xs:element name=“Parameter”
sql:relation=“MetaDataParameterList”
sql:relationship=“MetaData_Parameter”
                    minOccurs=“0” maxOccurs=“100”>
                    <xs:complexType>
                        <xs:attribute name=“name”
sql:field=“parameterName” use=“required”>
                            <xs:simpleType>
                    <xs:restriction base=“NoneEmptyString”>
                        <xs:maxLength value=“50” />
                                </xs:restriction>
                            </xs:simpleType>
                        </xs:attribute>
                <xs:attribute name=“value”
sql:field=“parameterValue” use=“optional”>
                        <xs:simpleType>
                    <xs:restriction base=“xs:string”>
                        <xs:maxLength value=“250” />
                            </xs:restriction>
                            </xs:simpleType>
                        </xs:attribute>
                    </xs:complexType>
                </xs:element>
            </xs:sequence>
        </xs:complexType>
        <xs:unique name=“UniqueParameterPerMetaData”>
            <xs:selector xpath=“Parameter” />
            <xs:field xpath=“@name” />
        </xs:unique>
    </xs:element>
    <xs:element name=“Globalization” sql:is-constant=“1”>
<xs:complexType><xs:sequence><xs:element name=“Locale”
sql:relation=“MetaDataLocaleList” sql:relationship=“MetaData_Locale”
minOccurs=“1” maxOccurs=“30”><xs:complexType><xs:attribute
name=“countryCode”use=“required”sql:field=“countryCode”>
<xs:simpleType><xs:restriction base=“xs:string”>
<xs:enumeration value=“*” /><xs:enumeration value=“at” />
<xs:enumeration value=“be” /><xs:enumeration value=“ca” />
<xs:enumeration value=“ch” /><xs:enumeration value=“cz” />
<xs:enumeration value=“de” /><xs:enumeration value=“dk” />
<xs:enumeration value=“es” /><xs:enumeration value=“fi” />
<xs:enumeration value=“fr” /><xs:enumeration value=“gb” />
<xs:enumeration value=“gr” /><xs:enumeration value=“hk” />
<xs:enumeration value=“ie” /><xs:enumeration value=“it” />
<xs:enumeration value=“in” /><xs:enumeration value=“jp” />
<xs:enumeration value=“kr” /><xs:enumeration value=“mx” />
<xs:enumeration value=“nl” /><xs:enumeration value=“nz” />
<xs:enumeration value=“no” /><xs:enumeration value=“po” />
<xs:enumeration value=“pl” /><xs:enumeration value=“pt” />
<xs:enumeration value=“ru” /><xs:enumeration value=“se” />
<xs:enumeration value=“sk” /><xs:enumeration value=“sg” />
<xs:enumeration value=“tw” /><xs:enumeration value=“tr” />
<xs:enumeration value=“uk” /><xs:enumeration value=“us” />
</xs:restriction></xs:simpleType></xs:attribute><xs:attribute
name=“languageId” use=“required” sql:field=“languageId”>
<xs:simpleType><xs:restriction base=“xs:string”>
<xs:enumeration value=“*” /><xs:enumeration value=“en” />
<xs:enumeration value=“sv” /><xs:enumeration value=“no” />
<xs:enumeration value=“da” /><xs:enumeration value=“fi” />
<xs:enumeration value=“es” /><xs:enumeration value=“pt” />
<xs:enumeration value=“ru” /><xs:enumeration value=“pi” />
<xs:enumeration value=“es” /><xs:enumeration value=“cs” />
<xs:enumeration value=“sk” /><xs:enumeration value=“tr” />
    </xs:restriction> </xs:simpleType></xs:attribute>
    </xs:complexType> </xs:element>
    </xs:sequence></xs:complexType></xs:element></xs:schema>
```

### Appendix H

Exemplary input and output for the directory service is shown below.

```
Input
-----
[ClientVersion] - [6.0.1234.0]
[ClientId] - [5ce3270a-2555-4f9f-8688-7a4da93ae16d]
[CountryCode] - [us]
[SecurityToken] -
[2CD7D6C25DCE89F43D0D3E5AFEF19D6BDB5CD36D037E3FCAD954C7C6C8C9B435
2FEEE01A1D9A744114F0B9BE1B1232E2316243C2940FAF158229FDEABAC9D5DCDA
41465230FBEAB4BB2811C4A57989308A92BC6E95507ABA]
[LanguageId] - [en]
[TestKey] - [ ]
[ClientType] - [ehome]
[PrefferedStart] - [09:00:00]
[PrefferedDuration] - [PT6H]
Output
------
The MXF is
<MXF version=“1.0” xmlns=“”>
    <Assembly name=“mcstore”>
        <NameSpace name=“Microsoft.MediaCenter.Store”>
            <Type name=“Provider” />
            <Type name=“UId” parentFieldName=“target” />
            <Type name=“Package” />
            <Type name=“PackageDeliveryInfo” />
            <Type name=“WebServiceLocator” />
        </NameSpace>
    </Assembly>
    <Provider id=“WMIS”>
        <UId>!Microsoft.MediaCenter.ProviderNames!WMIS</UId>
    </Provider>
    <StoredObjects provider=“WMIS”>
        <WebServiceLocators>
            <WebServiceLocator id=“Test” protocol=“MDP”
url=“https://Test.NA”>
    <UId>!Microsoft.WindowsMedia.Services.Platform.Apps.Mdp.Services!Test
NA</UId>
            </WebServiceLocator>
            <WebServiceLocator id=“PackageDelivery” protocol=“MDP”
url=“https://WMISDev-Lite01/packagedelivery/PackageDelivery.asmx”>
    <UId>!Microsoft.WindowsMedia.Services.Platform.Apps.Mdp.Services!Package
Delivery Service</UId>
            </WebServiceLocator>
            <WebServiceLocator id=“DirectoryService” protocol=“MDP”
url=“https://WMISDev-Lite01/Directory/DirectoryService.asmx”>
    <UId>!Microsoft.WindowsMedia.Services.Platform.Apps.Mdp.Services!Directory
Service</UId>
            </WebServiceLocator>
            <WebServiceLocator id=“Discovery” protocol=“MDP”
url=“https://WMISDev-Lite01/discovery/DiscoveryService.asmx”>
    <UId>!Microsoft.WindowsMedia.Services.Platform.Apps.Mdp.Services!Discovery
Service</UId>
            </WebServiceLocator>
        </WebServiceLocators>
        <Packages>
            <Package id=“ATSC” availableVersion=“20050815.1200”
isSecure=“True”>
    <UId>!Microsoft.WindowsMedia.Services.Platform.Apps.Mdp.Packages!Test ATSC
NA</UId>
            </Package>
            <Package id=“SportsTemplate” availableVersion=“”
isSecure=“True”>
    <UId>!Microsoft.WindowsMedia.Services.Platform.Apps.Mdp.Packages!Sports
Template</UId>
            </Package>
            <Package id=“SportsSchedule” availableVersion=“”
isSecure=“True”>
    <UId>!Microsoft.WindowsMedia.Services.Platform.Apps.Mdp.Packages!Sports
Template</UId>
            </Package>
            <Package id=“SportsSchedule” availableVersion=“”
isSecure=“True”>
    <UId>!Microsoft.WindowsMedia.Services.Platform.Apps.Mdp.Packages!Sports
Schedule</UId>
            </Package>
            <Package id=“Directory” availableVersion=“20050815.1200”
isSecure=“True”>
    <UId>!Microsoft.WindowsMedia.Services.Platform.Apps.Mdp.Packages!Directory</
UId>
            </Package>
            <Package id=“ClientUpdate” availableVersion=“” isSecure=“True”>
    <UId>!Microsoft.WindowsMedia.Services.Platform.Apps.Mdp.Packages!Client
Update</UId>
            </Package>
            <Package id=“Discovery” availableVersion=“” isSecure=“True”>
    <UId>!Microsoft.WindowsMedia.Services.Platform.Apps.Mdp.Packages!Discovery<
/UId>
            </Package>
        </Packages>
        <PackageDeliveryInfos>
            <PackageDeliveryInfo webServiceLocator=“Test” package=“ATSC”
downloadDelta=“P1D” downloadFrequency=“1” startTime=“11:00:00Z” duration=“PT1H”
retryCount=“3” retryBackOffMin=“PT5M” retryBackOffMax=“PT15M” />
            <PackageDeliveryInfo webServiceLocator=“PackageDelivery”
package=“SportsTemplate” downloadDelta=“P1D” downloadFrequency=“1”
startTime=“11:00:00Z” duration=“PT1H” retryCount=“3” retryBackOffMin=“PT5M”
retryBackOftMax=“PT15M” />
            <PackageDeliveryInfo webServiceLocator=“PackageDelivery”
package=“SportsSchedule” downloadDelta=“P1D” downloadFrequency=“2”
startTime=“11:00:00Z” duration=“PT1H” retryCount=“3” retryBackOffMin=“PT5M”
retryBackOffMax=“PT15M” />
            <PackageDeliveryInfo webServiceLocator=“DirectoryService”
package=“Directory” downloadDelta=“P1D” downloadFrequency=“1”
startTime=“11:00:00Z” duration=“PT1H” retryCount=“3” retryBackOffMin=“PT5M”
retryBackOffMax=“PT15M”>
                <parameters>
                    <KeyValue key=“PreferredDownloadStartTime”
value=“” />
                    <KeyValue key=“PreferredDownloadDuration”
value=“” />
                </parameters>
            </PackageDeliveryInfo>
            <PackageDeliveryInfo webServiceLocator=“PackageDelivery”
package=“ClientUpdate” downloadDelta=“P1D” downloadFrequency=“1”
startTime=“11:00:00Z” duration=“PT1H” retryCount=“3” retryBackOffMin=“PT5M”
retryBackOffMax=“PT15M” />
            <PackageDeliveryInfo webServiceLocator=“Discovery”
package=“Discovery” downloadDelta=“P1D” downloadFrequency=“1”
startTime=“11:00:00Z” duration=“PT1H” retryCount=“3” retryBackOffMin=“PT5M”
retryBackOffMax=“PT15M” />
        </PackageDeliveryInfos>
    </StoredObjects>
</MXF>
```

### Appendix I

The contents of an exemplary service list are described below.

Element <MetaData>

In general, the client has 2 types of ways to get metadata from WMIS service:
As a Web Service response
As a Package
   While Directory Service itself does not care in which way the client will contact the WMIS service and get the meta data, the final MXF output are different for the 2 types of meta data—the client will then decide how to contact with the service,

The <MetaData> element has the following list of attributes:

| Attribute | Attribute | |
|---|---|---|
| Name | Type | Description |
| Name | String | Used by directory service internally. Sample |
| | | “EpgService” |
| testKey | String | Client will pass in this value. Sample “EpgTest” |
| isSecure | Boolean | Set to “true” to enable the security token |
| type | String | “Package” or “WebService”, see samples below |

Sample 1: type set to “Package”

```
<WebServiceLocators>
        <WebServiceLocator id=”MDP CAB” protocol=”MDP”
    url=”http://somewhere.com/CABs”/>
</WebServiceLocators>
<Packages>
    <Package id=”Directory Service” >
        <UId nameSpace=”WMIS.Packages” value=”Directory
        Service”>
    </Package>
</Packages>
<PackageDeliveryInfoList>
    <PackageDeliveryInfo package=”Directory Service”
    webServiceLocator=”MDP CAB”
    downloadDelta=”P1dT”
    donwloadFrequency =”1” startTime=”9:00” duration=”PT1h” >
        <parameters>
            <KeyValue key=”Region”/>
            <KeyValue key=”PostalCode”/>
        </parameters>
    </PackageDeliveryInfo >
</PakageDeliveryInfoList>
```

Sample 2: type set to “WebService”

```
<WebServiceLocators>
  <WebServiceLocator id=“Sports” protocol=”Sports WebService”
  url=”http://fsn.cam/SportsData”>
    <UId namespace=”Microsoft.MediaCenter.WebServices”
    value=”Sports
  Live” />
  </WebServiceLocator>
</WebServiceLocators>
```

In both samples, UID will be calculated using hard-coded namespace and the name of the element.

The <MetaData> element has the following list of child elements:
<Download>
   This element defines the download schedule/retry info of the service.

The download info will be grouped into tree sub elements—<Schedule>, <Retry> and <ParameterList>.
<Globalization>

This element defines the globalization info of the service.

Max number of locales per meta data is 30.

Element <Schedule>

The <Schedule> element has the following list of attributes:

| | Attribute | |
|---|---|---|
| Attribute Name | Type | Description |
| ClientDownloadDelta | Duration | Must in full days. Fraction |
| | | of day will be ignored. |
| ClientDownloadFrequency | short | The value should between |
| | | (include) 1 to 10. |
| ClientDownloadWindowWidth | Duration | Client download window |
| | | width. |
| | | Client will randomly pick |
| | | a time within the window |
| | | to start the download. |
| | | Value should between |
| | | (include) 30 min to 2 hours. |
| loadBalanceOffsetSeed | Duration | Used by the load balance |
| | | algorithm to calculate the |
| | | download window start |
| | | time. |
| | | Value should between |
| | | (include) 1 min to 1 hour. |

The download schedule is defined by using the above attributes.

ClientDownloadDelta and ClientDownloadFrequency tell the clients how often they should download the package.

The client will follow the logic that to make x download in y days where x is defined by ClientDownloadFrequency, and y is defined by ClientDownloadDelta.

ClientDownloadWindowStartTime (see description below) and ClientDownloadWindowWidth define the client download window of a day.

ClientDownloadWindowStartTime is a calculated value using the following logic:

Abbreviations:

| | |
|---|---|
| Client Download Window Start Time | CDWS |
| Client Download Window Width | CDWW |
| Client Preferred Download Window Start Time | CPDWS |
| Client Preferred Download Window Width | CPDWW |
| Client download window | CDW |
| Client preferred download window | CPDW |
| Load BalanceOffset Seed | LBOS |
| Client ID Hash | CIH |

CDWS and CDWW define the CDW.
CPDWS and CPDWW define the CPDW.
CDW should always fit inside CPDW, which means that:
   CPDWS<=CDWS<=CPDWS+CPDWW-CDWW
However, not all values satisfy the above formula could be used as CDWS.
Directory Service will make sure there is a fixed duration between each valid CDWS, this fixed duration is defined by loadBalanceOffsetSeed.
Directory Service will pick CPDWS as the smallest possible value for CDWS.
Therefore, other valid CDWS could be
   CDWS=CPDWS+N* LBOS
   N is a integer, N>=0
Consider that CDWS<=CPDWS+CPDWW-CDWW, we have
   N<=(CPDWW-CDWW)/LBOS
   Or p2 Max(N)=(CPDWW-CDWW)/LBOS
Using
   N=CIH % (Max(N)+1)
We will get the N for a specific client.
Finally, for a specific client, we have

$$\begin{matrix}CDWS = CPDWS + ( CIH \% ( Max ( N ) + 1 ) ) * LBOS \\ = CPDWS + ( CIH \% ( \begin{matrix}CPDWW - \\ CDWW\end{matrix} ) / LBOS + 1 ) * LBOS\end{matrix}$$
If client has no CPDWS and CPDWW, directory service will use UTC 0:00 as CPDWS and 24 hours as CPDWW
   Element <Retry>

The <Retry> element has the following list of attributes:

| Attribute | Attribute | |
|---|---|---|
| Name | Type | Description |
| maxCount | Integer | Max number of retries. The biggest value |
| | | allowed is 10. |
| backOffMin | Duration | Minimum back off duration between the retries. |
| | | Value between(include)1 min to 5 min. |
| backOffMax | Duration | Maximum back off duration between the |
| | | retries. |
| | | Value between(include)15 min to 1 hour. |

Element <ParameterList>

The <ParameterList> element is an optional element and closely integrated with the MDP. Max number of parameters for each meta data is 100.

The web method defined by MDP requires a list of parameters to be passed in public XmlNode GetPackage(string versionId,IDictionary parameters)

The MCE client uses a generic proxy Download Manager to download all packages—therefore the Download Manager need to know what parameters are required for a specific service.

The <ParameterList> element defines the list of input name-value pairs by using the <Parameter> element.

The <Parameter> element has the following list of attributes:

| Attribute | Attribute | |
|---|---|---|
| Name | Type | Description |
| name | string | Name of the input parameter |
| value | string | Value of the input parameter. |
| | | If set to null, the client will set the value. |
| | | If set to a value, the client will send the same |
| | | value back |

Element <Globalization>

The globalization element has a list of <Country> elements.

Element <Country>

The <Country> element has the following list of attributes:

| Attribute Name | Attribute Type | Description |
|---|---|---|
| code | string | 2 character country code |

The <Country> element has a list language element.

Element <Language>

The <Language> element has the following list of attributes:

| | | |
|---|---|---|
| Attribute Name | Attribute Type | Description |

| | |
|---|---|
| id | Char(3) |

Usage (Sample XML)

```
<ServiceList>
  <Service name=“Directory Service” protocal=“MDP”
url=“http://WMISDev_Lite01/DirectoryService/DirectoryService.asmx”>
    <MataData name=“Directory Service” testKey=“” type=“Package”>
      <Download>
        <Schedule clientDownloadDelta =“P1D” clientDownloadFrequency =“1”
clientDownloadWindowWidth=“PT1H” loadBalanceOffsetSeed=“PT1H” />
        <Retry maxCount=“3” backOffMin=“PT5M” backOffMax=“PT15M” />
      </Download>
      <Globalization>
        <Country code=“*”><Language id=“*”/></Country>
      </Globalization>
    </MataData>
  </Service>
  <Service name=“Package Delivery Service” protocal=“MDP”
url=“http://WMISDev_Lite01/PackageDelievery/PackageDelievery.asmx”>
    <MataData name=“Sports Template Package” testKey=“” type=“Package”>
      <Download>
        <Schedule clientDownloadDelta =“P1D” clientDownloadFrequency =“2”
clientDownloadWindowWidth=“PT30M” loadBalanceOffsetSeed=“PT1H” />
        <Retry maxCount=“3” backOffMin=“PT5M” backOffMax=“PT15M” />
      </Download>
      <Globalization>
        <Country code=“us”><Language id=“en”/></Country>
      </Globalization>
    </MataData>
    <MataData name=“Sports Schedule Package” testKey=“” type=“Package”>
      <Download>
        <Schedule clientDownloadDelta =“P1D” clientDownloadFrequency =“2”
clientDownloadWindowWidth=“PT30M” loadBalanceOffsetSeed=“PT1H” />
        <Retry maxCount=“3” backOffMin=“PT5M” backOffMax=“PT15M” />
      </Download>
      <Globalization>
        <Country code=“us”><Language id=“en”/></Country>
      </Globalization>
    </MataData>
    <MataData name=“Client Update Package” testKey=“” type=“Package”>
      <Download>
        <Schedule clientDownloadDelta =“P1D” clientDownloadFrequency =“2”
clientDownloadWindowWidth=“PT30M” loadBalanceOffsetSeed=“PT1H” />
        <Retry maxCount=“3” backOffMin“PT5M” backOffMax=“PT15M” />
      </Download>
      <Globalization>
        <Country code=“*”><Language id=“*”/></Country>
      </Globalization>
    </MataData>
  </Service>
  <Service name=“Discovery Service” protocal=“MDP”
url=“http://WMISDev_Lite01/Discovery/DiscoveryService.asmx”>
    <MataData name=“Discovery Service Response” testKey=“” type=“Web Service”>
      <Download>
        <Schedule clientDownloadDelta =“P1D” clientDownloadFrequency =“1”
clientDownloadWindowWidth=“PT1H” loadBalanceOffsetSeed=“PT1H” />
        <Retry maxCount=“3” backOffMin=“PT5M” backOffMax=“PT15M” />
      </Download>
      <Globalization>
        <Country code=“us”><Language id=“en”/></Country>
      </Globalization>
    </MataData>
  </Service>
</ServiceList>
```

Element <Client>
Definition

The <Client> element has the following list of attributes:

| Attribute | Attribute | |
|---|---|---|
| Name | Type | Description |
| Type | String | Client will pass in this value. Sample “eHome” |
| Version | String | Client will pass in this value. Sample “2.1” |

The <Client> element has a child element <AvailableMetaData>, which contains a list of meta data available to the client.

Element <MetaData>

The <MetaData> element has the following list of attributes:

| Attribute | Attribute | |
|---|---|---|
| Name | Type | Description |
| name | String | The unique name of the meta data. Refer to the |
| | | name defined by the <MetaData> element |
| | | inside <Service>. |

Element <MXFHeader>

The result xml in MXF has a section describes the client object model used by the client only. Consider the fact it is directly linked to the client object model, it is static for each client (type/version).

Sample MXF Header:

```
<Assembly name=”mcstore.dll” version=”6.0.5045.0”>
  <NameSpace name=”Microsaft.MediaCenter.Store”>
    <Type name=“StoredObject”/>
    <Type name=“Provider”/>
    <Type name=”UId” parentFieldName”target”/>
    <Type name=”Package”/>
    <Type name=”PackageDeliveryService/>
    <Type name=”WebServiceLocator”/>
  </NameSpace>
</Assembly>
<Provider id=“WMIS”>
  <UId>!Microsoft.MediaCenter.ProviderNames!WMIS</UId>
</Provider>
```

Usage: Sample XML

```
<ClientList>
  <Client type=“eHome” version=“4.0”>
    <AvailableServices>
      <Service name=“Directory Service”>
        <MetaData name=“Directary Service Package”/>
      </Service>
      <Service name=“Package Delivery Service”>
        <MetaData name=“Sports Template Package”>
        <MetaData name=“Sports Schedule Package”/>
        <MetaData name=“Client Update Package”/>
      </Service>
      <Service name=“Discovery Service”>
        <MetaData name=“Discovery Service Response”/>
      </Service>
    </AvailableServices>
  </Client>
</ClientList>
```

### Appendix J

Directory Service Pipe Line Stages

Data Collector Service (DCS)

The current schedule is to poll every day changes to the following file which uses the schema defined by the previous section:
DirectoryService.XML

The polling interval can be fully adjusted via standard configuration.

The stage will be consists of the following major elements:
Output Pipe:
The output of the stage will be a file output pipe which contains the file
DirectoryService.XML
   Directory Service Data Loading Service (DLS)
Main Process:
The main process of the stage will be a dts package
DirecotryService_LoadXml, which loads the XML file to the data base

Directory Service Publication Copy (PCS)

```
<StoredObjects provider=”WMIS”>
  <WebServiceLocators>
    <WebServiceLocator id=”MDP CAB” protocol=”MDP” url=“http://somewhere.com/CABs”/>
    <WebServiceLocator id=”Guide Listings” protocol=”MDP”
  url=”http://epg.microsoft.com/Listings”/>
    <WebServiceLocator id=”Sports” protocol=”Sports WebService” url=”http://fsn.com/SportsData”>
      <UId namespace=”Microsoft.MediaCenter.WebServices” value=”Sports Live” />
    </WebServiceLocator>
  </WebServiceLocators>
  <Packages>
    <Package id=”Directory Service” >
      <UId nameSpace=”WMIS.Packages” value=”Directory Service”>
    </Package>
    <Package id=”Headends” availableVersion=”1234”>
      <UId nameSpace=”WMIS.Packages” value=”Headends”>
    </Package>
    <Package id=”ATSC Listings” >
      <UID nameSpace=”WMIS.Packages” value=”ATSC Listings”>
    </Package>
  </Packages>
  < PackageDeliveryInfoList>
    <PackageDeliveryInfo package=”Directory Service” webServiceLocator=”MDP CAB”
  downloadDelta=”P1dT”
    donwloadFrequency =”1” startTime=”9:00” duration=”PT1h” >
      <parameters>
        <KeyValue key=”Region”/>
        <KeyValue key=”PostalCode”/>
      </parameters>
    </PackageDeliveryInfo >
    < PackageDeliveryInfo package=”Headends” webServiceLocator=”MDP CAB”
  downloadDelta=”P5dT”
    donwloadFrequency =”1” startTime=”9:00” duration=”PT1h”>
      <parameters>
        <KeyValue key=”Region”/>
        <KeyValue key=”PostalCode”/>
      </parameters>
    </ PackageDeliveryInfo >
    < PackageDeliveryInfo package=”ATSC Listings” webServiceLocator=”Guide Listings”
  downloadDelta=”P1dT”
    donwloadFrequency =”1” startTime=”9:00” duration=”PT3h” >
      <parameters>
        <KeyValue key=”Region”/>
        <KeyValue key=”PostalCode”/>
      </parameters>
    </ PackageDeliveryInfo >
  </ PackageDeliveryInfoList>
</StoredObjects>
```

Directory Service Publication Activation (PAS)
Directory Service Web Service

The web interface defined by the MDP has the following web method.

public XmlNode GetPackage(string versionid, IDictionary parameters)

Input:
   SOAP header:
   The following information is passed to the web method through the SOAP header and will be used by this method:
      Test key
      Country code
      Locale
      Client type
      Client version
   The following information is passed to the web method through the parameters as a list of name-value pairs:
      Client preferred download window start
      Client preferred download window duration
Output:
   XmlNode:
   The output XmlNode will contain a list of service info.

Sample XML Output:

```
<MXF version=”1.0”>
<Assembly name=”mcstore.dll” version=”6.0.5045.0”>
  <NameSpace name=”Microsoft.MediaCenter.Store”>
    <Type name=“StoredObject”/>
    <Type name=“Provider”/>
    <Type name=”UId” parentFieldName=”target”/>
    <Type name=”Package”/>
    <Type name=”PackageDeliveryService/>
    <Type name=”WebServiceLocator”/>
  </NameSpace>
</Assembly>
<Provider id=“WMIS”>
  <UId>!Microsoft.MediaCenter.ProviderNames!WMIS</UId>
</Provider>
<StoredObjects provider=”WMIS”>
  <WebServiceLocators>
    <WebServiceLocator id=”MDP CAB” protocol=”MDP” url=”http://somewhere.com/CABs”/>
    <WebServiceLocator id=”Guide Listings” protocol=”MDP”
  url=”http://epg.microsoft.com/Listings”/>
    <WebServiceLocator id=”Sports” protocol=”Sports WebService” url=”http://fsn.com/SportsData”>
      <UId namespace=”Microsoft.MediaCenter.WebServices” value=”Sports Live” />
    </WebServiceLocator>
  </WebServiceLocators>
  <Packages>
    <Package id=”Directory Service” >
      <UId nameSpace=”WMIS.Packages” value=”Directory Service”>
    </Package>
    <Package id=”Headends” availableVersion=”1234”>
      <UId nameSpace=”WMIS.Packages” value=”Headends”>
    </Package>
    <Package id=”ATSC Listings” >
      <UId nameSpace=”WMIS.Packages” value=”ATSC Listings”>
    </Package>
  </Packages>
  < PackageDeliveryInfoList>
    <PackageDeliveryInfo package=”Directory Service” webServiceLocator=”MDP CAB”
  downloadDelta=”P1dT”
    donwloadFrequency =”1” startTime=”9:00” duration=”PT1h” >
      <parameters>
        <KeyValue key=”Region”/>
        <KeyValue key=”PostalCode”/>
      </parameters>
    </PackageDeliveryInfo >
    < PackageDeliveryInfo package=”Headends” webServiceLocator=”MDP CAB”
  downloadDelta=”P5dT”
    donwloadFrequency =”1” startTime=”9:00” duration=”PT1h” >
      <parameters>
        <KeyValue key=”Region”/>
        <KeyValue key=”PostalCode”/>
      </parameters>
    </ PackageDeliveryInfo >
    < PackageDeliveryInfo package=”ATSC Listings” webServiceLocator=”Guide Listings”
  downloadDelta=”P1dT”
    donwloadFrequency =”1” startTime=”9:00” duration=”PT1h” >
      <parameters>
        <KeyValue key=”Region”/>
        <KeyValue key=”PostalCode”/>
      </parameters>
    </ PackageDeliveryInfo >
  </ PackageDeliveryInfoList>
</StoredObjects>
</MXF>
```

### Appendix K

PDS Backend

The high level components of the Package Delivery Service (PDS) will be multiple DCS pipeline stages, multiple FPS pipeline stages, and a web service. The DCSs will collect provider package and manifest files from a web folder. The FPS stages will process packages from the web folder, and also process sports packages from WMIS. The FPS stages will validate that each package file has been digitally signed if the “CheckCodeSign” flag is set in the manifest, and that each manifest file is valid. Each FPS will create a new version for the package, encrypt the files if needed, and copy the packages to a location accessible by the PDS web service.

Each package is a file or a group of files, and each package has a manifest file describing the package. Data providers provide the manifest file when providing the package.
Manifest schema (PDSManifest.xsd) used to define the data packages provided by various data providers outside or within WMIS. The schema defines the following:
   Client configuration filter settings
   MCE Client version's supported
   Latest package version available on the server
      Web folder Structure:
The web folder will follow a flat structure and packages will have a manifest file that will describe the package file details. The manifest file should have the following information:
   Country
   Package Name
   Package Version
   File Name
   OEM
   Client Version
   Encryption Key [optional]
      Data Collection Service Pipeline Stages

The two DCSs will be a typical WMIS Data Collation Stages for “client update” and “sports template” packages. Each DCS will collect the provider packages and manifest files from a web folder. Creating the new DCSs will be done using the config system. Each DCS will look at the same web folder, but at a different file specifying the package type. At the top level of the web folder there will be a folder called “ClientUpdate” and a folder called “SportsTemplate”.

File Propagation Service Pipeline Stage

The FPS pipeline stages will process the package files with these steps:
1. Get package type and manifest files from DCSs/or get ‘sports schedule’ package and manifest files from the sports pipeline
2. Validate manifest against an XSD
3. For each .cab file:
   a. Verify a correct filename
   b. Verify allowable file size
   c. Verify a digital signature (if CheckCodeSign flag is true in config)
   d. Verify a valid cab file format
4. Encrypt the .cab files and generate a hash for the file, if the “EncryptionByPDS” flag is set in the manifest.
5. Make the packages available for download through the web service (copy the files to a location on the web server)

The FPS stages will be configured to get packages from either a DCS stage or the WMIS sports pipeline.

Initially there will be three web folders for dev, test, and int environments. In these folders there will be a folder called “ClientUpdate” and a folder called “SportsTemplate”. Files will also follow the naming convention of: <package name>-<file version>-<client version>-<OEM>-<MMDDYYYY>.cab.

The final step above will be achieved with a Robocopy step to get the files to the output directory. Also the TK server will be used.

The end result of the FPS stage will be that the files on the web server are exactly the same as the files in the folder. That is, when a package is added to the folder, it will end up on the web server available for download. Or, if a package is deleted from the web folder, it will no longer be available for download. If any file fails a validation step, the entire FPS for that package type will fail.

### Appendix L

A sample manifest file for the package delivery service is shown below.

```
  <?xml version=“1.0” encoding=“UTF-8” standalone=“no” ?>
<Package name=“ClientUpdate” encryptionByPDS=“false”
  xmlns:xsi=“http://www.w3.org/2001/XMLSchema-instance”>
<Filter name=“OEM” value=“*”>
<Filter name=“CountryCode” value=“*”>
<Filter name=“ClientVersion” value=“6.0”>
  <!--
  This package will go to all OEMs in all countries for 6.0 clients
  -->
  <PackageFile name=“ClientUpdate-1.0-6.0-ALL-20050829.cab”
    fileVersion=“1.0” />
    </Filter>
    </Filter>
    </Filter>
    </Package >
```

### Appendix M

Sample input and output for the package delivery service is shown below.

```
Input
-----
[ClientVersion] - [6.0.1234.0]
[ClientId] - [5ce3270a-2555-4f9f-8688-7a4da93ae16d]
[CountryCode] - [us]
[PackageName] - [SportsSchedule]
[Oem] - [dell]
[PackageVersion] - [20050809.1450]
[SecurityToken] -
[2CD7D6C25DCE89F43D0D3E5AFEF19D6BDB5CD36D037E3FCAD954C7C6C8
C9B4352FEEE01A1D9A744114F0B9BE1B1232E2316243C2940FAF158229FDEA
BAC9D5DCDA41465230FBEAB4BB2811C4A57989308A92BC6E95507ABA]
[LanguageId] - [en]
[Invalid] - [PackageName]
[OemModel] - [1]
[TestKey] - [12345]
[ClientType] - [ehome]
[TimeZone] - [1]
Output
------
The MXF is
<MXF version=“1.0” xmlns=“”>
  <Assembly name=“mcstore”>
    <NameSpace name=“Microsoft.MediaCenter.Store”>
      <Type name=“Attachment” parentFieldName=“Package” />
      <Type name=“Package” />
      <Type name=“UId” parentFieldName = “target” />
      <Type name=“Provider” />
    <Name Space>
  </Assembly>
  <Provider id=“WMIS”>
    <UId>!Microsoft.MediaCenter.ProviderNames!WMIS</UId>
  </Provider>
  <StoredObjects provider=“WMIS”>
    <Package id=“SportsSchedule” version=“20050916.0737”>
  <UId>!Microsoft.WindowsMedia.Services.Platform.Apps.Mdp.Packages!Sports
Schedule</UId>
    </Package>
    <Attachment package=“SportsSchedule” name=“SportsSchedule”
fileVersion=“495595035668”
url=“http://YINGLITESERVER:1700/packagedeliverydata/SportsSchedule/SportsSchedule
-495595035668.0-4.00-All-20050914.enc”
IV=“guI3Zx/wbDOWXO8wvD1ehQ==”
key=“Wx/Jz0mTEGKuTjq9VVBy8yB/wgvifi3/dIoOmOipNpk=”
signature=“IPk27MYrcrfrXyvSIEpyzN3EKptLm0xemBgbGTQpKbc=”
encryptionMethod=“AES128” signingMethod=“SHA256”
microsoftCodeSigned=“False” />
  </StoredObjects>
</MXF>
```

### Appendix N

An exemplary schema definition for a manifest file in the package delivery service is shown below.

```
<?xml version=“1.0” encoding=“UTF-8”?>
<xs:schema xmlns:xs=“http://www.w3.org/2001/XMLSchema”
elementFormDefault=“qualified”>
  <xs:simpleType name=“ValidPackageFileName”>
    <xs:restriction base=“xs:string”>
      <xs:annotation>
        <xs:documentation>Enforce file naming
convention of PackageName-PackageVersion-ClientVersion-OEM-
YYYYMMDD.cab</xs:documentation>
      </xs:annotation>
      <xs:minLength value=“5”/>
      <xs:maxLength value=“225”/>
      <xs:pattern value=“\w+−\d+(\. \d+)*−\d+(\. \d+)*−\w+−
\d{8}.cab”/>
    </xs:restriction>
  </xs:simpleType>
  <xs:element name=“PackageFile”>
    <xs:complexType>
      <xs:attribute name=“fileName”
type=“ValidPackageFileName” use=“required” />
      <xs:attribute name=“attachmentName” use=“required”>
        <xs:simpleType>
          <xs:restriction base=“xs:string”/>
        </xs:simpleType>
      </xs:attribute>
      <xs:attribute name=“availableVersion”
use=“required”>
        <xs:simpleType>
          <xs:restriction base=“xs:float”>
            <xs:minExclusixte value=“0”/>
          </xs:restriction>
        </xs:simpleType>
      </xs:attribute>
    </xs:complexType>
  </xs:element>
  <xs:element name=“Package”>
    </xs:complexType>
      <xs:sequence minOccurs=“0” maxOccurs=“unbounded”>
        <xs:element ref=“PackageFile” minOccurs=“0”
maxOccurs=“unbounded”/>
        <!-- first filter -->
        <xs:element name=“Filter” minOccurs=“0”
maxOccurs=“unbounded”>
          </xs:complexType>
            <x:sequence minOccurs=“0”
maxOccurs=“unbounded”>
              <xs:element
ref=“PackageFile” minOccurs=“0” maxOccurs=“unbounded”/>
              <!-- second filter -->
              <xs:element name=“Filter”
minOccurs=“0” maxOccurs=“unbounded”>
                <xs:complexType>
                  </xs:sequence
minOccurs=“0” maxOccurs=“unbounded”>
  <xs:element ref=“PackageFile” minOccurs=“0”
maxoccurs=“unbounded”/>
                    <!--
third filter -->
  <xs:element name=“Filter” minOccurs=“0” maxOccurs=“unbounded”>
  <xs:complexType>
  <xs:sequence minOccurs=“0” maxOccurs=“unbounded”>
    <xs:element ref=“PackageFile” maxOccurs=“unbounded”/>
  </xs:sequence>
  <xs:attribute name=“name” use=“required”>
    <xs:simpleType>
      <xs:restriction base=“xs:string”>
        <xs:enumeration value=“ClientVersion” />
        <xs:enumeration value=“CountryCode”/>
        <xs:enumeration value=“OEM”/>
      </xs:restriction>
    </xs:simpleType>
  </xs:attribute>
  <xs:attribute name=“value” type=“xs:string” use=“required”/>
  </xs:complexType>
  </xs:element>
                  </xs:sequence>
                  <xs:attribute
name=“name” use=“required”>
  <xs:simpleType>
  <xs:restriction base=“xs:string”>
  <xs:enumeration value=“ClientVersion”/>
  <xs:enumeration value=“CountryCode”/>
  <xs:enumeration value=“OEM”/>
  </xs:restriction>
  </xs:simpleType>
                  </xs:attribute>
                  <xs:attribute
name=“value” type=“xs:string” use=“required”/>
                </xs:complexType>
              </xs:element>
            </xs:sequence>
            <xs:attribute name=“name”
type=“xs:string” use=“required”/>
            <xs:attribute name=“value”
type=“xs:string” use=“required”/>
          </xs:complexType>
        </xs:element>
      </xs:sequence>
      <xs:attribute name=“encryptionByPDS”
type=“xs:boolean” use=“required”/>
      <xs:attribute name=“name” use=“required”>
        <xs:simpleType>
          <xs:restriction base=“xs:string”>
            <xs:enumeration
value=“ClientUpdate”/>
            <xs:enumeration
value=“SportsSchedule”/>
            <xs:enumeration
value=“SportsTemplate”/>
          </xs:restriction>
        </xs:simpleType>
      </xs:attribute>
    </xs:complexType>
    <xs:unique name=“UniqueFileName”>
      <xs:annotation>
        <xs:documentation>Enforce file name
uniqueness.</xs:documentation>
      </xs:annotation>
      <xs:selector xpath=“.//PackageFile”/>
      <xs:field xpath=“@name”/>
    </xs:unique>
  </xs:element>
</xs:schema>
```

What is claimed is:

1. A computerized method comprising:
receiving a request from an application program for one or more locations providing web services;
generating a list of the web services corresponding to the received request;
identifying the requested locations as a function of the generated list of the web services;
determining a schedule time associated with each of the identified locations to effectuate load management at the identified locations; and
sending information including the identified locations, the generated list of the web services, and the determined schedule times to the application program, wherein the application program accesses the web services at the identified locations at the determined schedule times.

2. The computerized method of claim 1, further comprising formatting the information according to a metadata download protocol, wherein the formatted information comprises a common header and further comprises the identified locations, the generated list of the web services, and the determined schedule times as objects.

3. The computerized method of claim 1, wherein identifying the requested locations comprises identifying the requested locations based on one or more of the following in the received request: client type, client version, client identifier, country code, language identifier, test key, time zone, original equipment manufacturer of a computing device executing the application program, and a model of the computing device executing the application program.

4. The computerized method of claim 1, further comprising generating a security token based on the received request prior to sending the identified locations, the generated list of the web services, and the determined schedule times to the application program.

5. The computerized method of claim 1, further comprising logging the received request.

6. The computerized method of claim 1, wherein the schedule time defines one or more of the following: a start time, a duration, download delta days, refresh hours, retry count, back off minimum, and back off maximum.

7. The computerized method of claim 1, further comprising validating the list of the web services based on a schema, said schema defining supported countries, supported languages, supported client versions, and the latest package version.

8. The computerized method of claim 1, wherein determining the schedule time associated with each of the identified locations comprises determining the schedule time based on a download window start time identified by the application program.

9. The computerized method of claim 1, wherein one or more computer-readable media have computer-executable instructions for performing the computerized method recited in claim 1.

10. A system comprising:
a memory area storing a service list having a plurality of service entries, each of said service entries comprising a location of a web service and a download schedule associated therewith; and
a processor configured to execute computer-executable instructions for:
receiving, from an application program, attributes associated with the application program;
filtering the service list to generate a list of services available to the application program based on the received attributes; and
sending the generated list of services to the application program.

11. The system of claim 10, further comprising means for determining and providing a list of web services available to the application program.

12. The system of claim 10, wherein the download schedule defines one or more of the following: a start time, a duration, download delta days, refresh hours, retry count, back off minimum, and back off maximum.

13. The system of claim 10, further comprising a data structure representing a schema to validate the service list stored in the memory area, said schema defining supported countries, supported languages, supported client versions, and the latest package version.

14. The system of claim 10, wherein the processor is further configured to execute computer-executable instructions for formatting the generated list of services according to a metadata download protocol to create objects.

15. The system of claim 10, wherein the processor is further configured to execute computer-executable instructions for filtering the service list based on one or more of the following: client type, client version, client identifier, country code, language identifier, time zone, original equipment manufacturer of a computing device executing the application program, and a model of the computing device executing the application program.

16. One or more computer-readable media having computer-executable components, said components comprising:
an interface component for receiving a request from an application program for one or more locations providing web services;
a services component for generating a list of the web services corresponding to the received request;
a location component for identifying the requested locations as a function of the generated list of the web services and for determining a schedule time associated with each of the identified locations to effectuate load management at the identified locations; and
a protocol component for formatting the identified locations, the generated list of the web services, and the determined schedule times according to a metadata download protocol to create formatted objects, wherein the interface component sends the formatted objects along with a common header to the application program, and wherein the application program accesses the web services at the identified locations at the determined schedule times.

17. The computer-readable media of claim 16, further comprising a security component for generating a security token based on the received request prior to sending the identified locations, the generated list of the web services, and the determined schedule times to the application program.

18. The computer-readable media of claim 16, wherein the schedule time defines one or more of the following: a start time, a duration, download delta days, refresh hours, retry count, back off minimum, and back off maximum.

19. The computer-readable media of claim 16, further comprising a data structure representing a schema to validate the list of the web services, said schema defining supported countries, supported languages, supported client versions, and the latest package version.

20. The computer-readable media of claim 16, wherein the location component identifies the requested locations based on one or more of the following in the received request: client type, client version, client identifier, country code, language identifier, time zone, original equipment manufacturer of a computing device executing the application program, and a model of the computing device executing the application program.
